(19) United States
(12) Patent Application Publication
(10) Pub. No.: US 2023/0143738 A1
(43) Pub. Date: May 11, 2023

(54) COMPUTER PROGRAM, METHOD, AND DEVICE FOR GENERATING VIRTUAL DEFECT IMAGE BY USING ARTIFICIAL INTELLIGENCE MODEL GENERATED ON BASIS OF USER INPUT

(71) Applicant: SAIGE RESEARCH INC., Seoul (KR)

(72) Inventors: Byung Heon KIM, Seoul (KR); Jin Kyu KIM, Seoul (KR)

(73) Assignee: SAIGE RESEARCH INC., Seoul (KR)

(21) Appl. No.: 17/918,455

(22) PCT Filed: Apr. 13, 2021
(86) PCT No.: PCT/KR2021/004611

§ 371 Date: Oct. 12, 2022

(30) Foreign Application Priority Data
Apr. 20, 2020 (KR) 10-2020-0047422

(51) Int. Cl. G06T 7/00

(52) U.S. Cl. CPC G06T 7/0008; G06T 2207/20081; G06T 2207/20104

(57) ABSTRACT

A method, performed by an electronic device, of generating a virtual defect image includes training a virtual defect image generation model based at least on a first normal image and a defect image of a first product, and a user input, and generating a virtual defect image from a second normal image of a second product by using the trained virtual defect image generation model.

### TECHNICAL FIELD

Embodiments of the present disclosure relate to a computer program, method, and device for generating a virtual defect image by using an artificial intelligence model generated based on user inputs.

### BACKGROUND ART

In general, an inspection is required to determine whether a defect exists in products of a factory. Recently, efforts have been made to reduce costs, for example, automation of production lines, and accordingly, interest in automation of quality inspection of products is also increasing. For example, machine vision technology that applies computer vision to machines, robots, processors, or quality control is being rapidly developed.

The related-art machine vision technology employs template matching, which includes a technique of simply extracting a reference template from an image (e.g., a picture) of a product or comparing an image of a product with a template, without any artificial intelligence concepts. For example, in the related art, machine vision involves creating an algorithm including rules for comparing pixel values of an image of a product with pixel values of a reference image and determining that the product is defective when the difference between the pixel values is within a certain range, or for measuring the length of a certain portion of an image of a product and determining that the product is defective when the length is within a certain range. That is, in machine vision, which does not use artificial intelligence, there is an issue in that all possible cases of defects need to be included in the algorithm, and it is difficult to detect atypical defects that are not definable by rules.

With the recent development of artificial intelligence technology, interest in a technique is increasing, in which artificial intelligence is applied to machine vision for detecting even atypical defects that are not definable by rules.

### DESCRIPTION OF EMBODIMENTS

### Technical Problem

As described above, for training an artificial intelligence model to detect a defect of a product, a plurality of images (e.g., pictures) of a product with the defect are required to be used as training data. For example, as the amount of training data increases, the performance of a defect detection artificial intelligence model may improve.

However, for a typical production line, it is significantly difficult to obtain a large number of images of defective products (hereinafter, referred to as defect images). In particular, because the number of defect images is extremely small at the beginning of the production line, it is impossible to train a meaningful defect detection artificial intelligence model, and thus the artificial intelligence model may be unavailable at the beginning of the production line.

Meanwhile, when using a method of slightly modifying a small number of defect images (i.e., actual defect images) to increase the amount of training data, newly generated images originate from existing images, and thus it is impossible to generate an image with a new defect image that does not exist at all. In addition, because a characteristic or complicated defect that may occur in a certain product is not definable by rules according to a product cannot represent rules, it is significantly difficult to generate an image of a product with a new defect image that does not exist.

The present disclosure has been made in an effort to solve the above-described issue, and provides a computer program, method, and device for generating a virtual defect image by using an artificial intelligence model generated based on user inputs.

However, this objective is merely illustrative, and the scope of the present disclosure is not limited thereto.

### Solution to Problem

According to an embodiment of the present disclosure, a method, performed by an electronic device, of generating a virtual defect image includes training a virtual defect image generation model based at least on a first normal image and a defect image of a first product, and a user input, and generating a virtual defect image from a second normal image of a second product by using the trained virtual defect image generation model. The generating of the virtual defect image may include generating the virtual defect image through the virtual defect image generation model by using information about a defect region of a preset shape, and generating the virtual defect image through the virtual defect image generation model by using manually marked region information based on an input made by a user for marking a region in which a defect is to be generated.

According to an embodiment, the first product and the second product may be of a completely same type or may be of a same type but have different standards or versions.

According to an embodiment, the first normal image and the second normal image may be identical to or different from each other.

According to an embodiment, the training of the virtual defect image generation model may include setting defect types, which are occurrable in the first product.

According to an embodiment, the generating of the virtual defect image may include receiving, based on a user input, information about a defect region in which each of at least some of the set defect types is occurrable.

According to an embodiment, the training of the virtual defect image generation model may include collecting data for a database based on first normal images and defect images of products of a plurality of different versions including the first product and performing preprocessing on the database, and training the virtual defect image generation model by selecting only some of the products of the plurality of different versions.

According to an embodiment of the present disclosure, a computer program may be stored in a computer-readable storage medium for executing the above-described operations by using a computer.

According to an embodiment of the present disclosure, a non-transitory computer-readable storage medium may store one or more programs for executing the above-described operations.

Other aspects, features, and advantages other than those described above will be apparent from the following drawings, claims, and detailed description.

### Advantageous Effects of Disclosure

The device, method, and computer program according to an embodiment of the present disclosure configured as described above may train a virtual defect image generation model for various types of products according to a user's needs, based on a user input, and generate a virtual defect image of a product according to the user's needs by using the trained virtual defect image generation model.

In addition, a virtual defect image with a new defect may be newly generated from a normal image, instead of by modifying an existing defect image.

Furthermore, various types of defects may be generated through one training process.

In addition, one virtual defect image generation model capable of generating a virtual defect image in both an automatic mode and a manual mode may be trained through one training process, which is performed based on a user input.

In addition, products of the same kind but having different detailed characteristics may be collected in one project and then used for training at once.

In addition, the device, method, and computer program according to an embodiment of the present disclosure may train various models based on a user input of selecting only products or defect types to be used for training from among a plurality of products or a plurality of defect types when training a generation model.

However, the scope of the present disclosure is not limited by these effects.

### BRIEF DESCRIPTION OF THE DRAWINGS

FIG. 1 illustrates an example of a functional configuration of an electronic device 10 for generating a virtual defect image, according to an embodiment of the present disclosure.

FIG. 2 illustrates an example of an overall operation S10 including an operation of generating a virtual defect image and a usage example thereof, according to an embodiment of the present disclosure.

FIG. 3 illustrates an example of a functional configuration of a program 16 for generating a virtual defect image, according to an embodiment of the present disclosure.

FIG. 4 illustrates an example of operations of a generation module 22 in an automatic mode and a manual mode, according to an embodiment of the present disclosure.

FIG. 5 illustrates an example of an operation, performed by an electronic device 10, of generating a virtual defect image, according to an embodiment of the present disclosure.

FIG. 6 illustrates an example of an operation, performed by an electronic device 10, of training a virtual defect image generation model, according to an embodiment of the present disclosure.

FIG. 7 illustrates an example of a screen A7 of a program 16 for generating a virtual defect image, according to an embodiment of the present disclosure.

FIG. 8 illustrates an example of an operation, performed by an electronic device 10, of building a database for training a virtual defect image generation model, according to an embodiment of the present disclosure.

FIG. 9 illustrates examples of products of one or more versions.

FIGS. 10 to 12 illustrate examples of screens for building a database according to an embodiment of the present disclosure.

FIG. 13 illustrates an example of an operation, performed by an electronic device 10, of performing preprocessing on a database for training a virtual defect image generation model, according to an embodiment of the present disclosure.

FIGS. 14 to 18 illustrate examples of screens of an electronic device 10 for performing preprocessing, according to an embodiment of the present disclosure.

FIG. 19 illustrates an example of a screen for training a virtual defect image generation model, according to an embodiment of the present disclosure.

FIG. 20 illustrates an example of an operation, performed by an electronic device 10, of generating a virtual defect image, according to an embodiment of the present disclosure.

FIGS. 21 to 27 illustrate examples of screens of an electronic device 10 for performing automatic-mode generation, according to an embodiment of the present disclosure.

FIG. 27 illustrates examples of virtual defect images generated in an automatic mode.

FIGS. 28 to 30 illustrate examples of screens for performing manual-mode generation, according to an embodiment of the present disclosure.

FIG. 31 illustrates examples of virtual defect images generated in a manual mode.

FIGS. 32 to 34 illustrate examples of a case in which automatic-mode generation of a virtual defect image is useful and a case in which the manual-mode generation of a virtual defect image is useful, according to an embodiment of the present disclosure.

### MODE OF DISCLOSURE

As the present disclosure allows for various changes and numerous embodiments, particular embodiments will be illustrated in the drawings and described in detail. The effects and features of the present disclosure and methods of achieving them will become clear with reference to the embodiments described in detail below with the drawings. However, the present disclosure is not limited to the embodiments disclosed below, and may be implemented in various forms.

Hereinafter, embodiments of the present disclosure will be described in detail with reference to the accompanying drawings, and the same or corresponding components will be denoted by the same reference numerals when described with reference to the accompanying drawings, and thus their descriptions that are already provided will be omitted.

While such terms as “first,” “second,” etc., are used only to distinguish one component from another, and such components must not be limited by these terms.

The singular expression also includes the plural meaning as long as it is not inconsistent with the context.

The terms “comprises,” “includes,” or “has” used herein specify the presence of stated features or elements, but do not preclude the presence or addition of one or more other features or elements.

For ease of description, the magnitude of components in the drawings may be exaggerated or reduced. For example, each component in the drawings is illustrated to have an arbitrary size and thickness for ease of description, and thus the present disclosure is not limited to the drawings.

In the following embodiments, when a region, component, block, or module is referred to as being connected to another region, component, block, or module, they may be directly connected to each other, or may be indirectly connected to each other with still another region, component, block, or module therebetween.

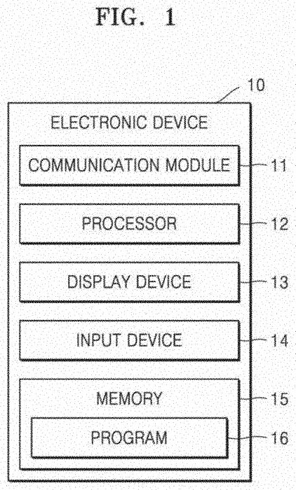

FIG. 1 illustrates an example of a functional configuration of an electronic device 10 for generating a virtual defect image, according to an embodiment of the present disclosure.

Referring to FIG. 1, the electronic device 10 may include a communication module 11, a processor 12, a display device 13, an input device 14, and a memory 15. The memory 15 may store a program 16 for training a virtual defect image generation model and generating a virtual defect image from a normal image by using the trained virtual defect image generation model.

Accordingly, the electronic device 10 may generate a virtual defect image by causing the processor 12 to execute the program 16. The electronic device 10 may include, for example, a portable communication device (e.g., a smart phone or a notebook computer), a computer device, a tablet personal computer (PC), or the like. However, the electronic device 10 is not limited to the above-described devices.

Also, the electronic device 10 is not limited to the above-described components, and other components may be added to the electronic device 10 or some components may be omitted from the electronic device 10.

The communication module 11 may support establishment of a wired or wireless communication channel between the electronic device 10 and an external electronic device (e.g., another electronic device or a server) and performing of communication via the established communication channel. The communication module 11 may include one or more communication processors that operate independently from the processor 12 (e.g., an application processor) and support wired or wireless communication. According to an embodiment, the communication module 11 may include a wireless communication module (e.g., a cellular communication module, a short-range wireless communication module, or a global navigation satellite system (GNSS) communication module) or a wired communication module (e.g., a local area network (LAN) communication module, or a power line communication module), and may communicate with an external electronic device through a short-range communication network (e.g., Bluetooth, WiFi direct, or Infrared Data Association (IrDA)) or a long-range communication network (e.g., a cellular network, the Internet, or a computer network (e.g., a LAN or a wide area network (WAN)), by using the communication module. The above-described various types of communication modules 11 may be implemented as a single chip or as separate chips.

At least part of a virtual defect image generating operation performed by the electronic device 10 according to an embodiment of the present disclosure may be performed through a wireless communication channel with a server (not shown) by using the communication module 11. For example, in a process in which the electronic device 10 trains a virtual defect image generation model based on user inputs and then generates a virtual defect image, at least partial data may be transmitted and received to and from the server (not shown).

The processor 12 may execute, for example, software (e.g., the program 16) to control at least one other component (e.g., a hardware or software component) of the electronic device 10 connected to the processor 12, and may perform various data processing and operations. The processor 12 may load a command or data received from another component (e.g., the input device 14) into the memory 15 (e.g., a volatile memory) and process the command or data, and store resulting data in the memory 15 (e.g., a nonvolatile memory).

The memory 15 may store various pieces of data used by at least one component (e.g., the processor 12) of the electronic device 10, for example, software (e.g., the program 16) and input data or output data for a command related to the software. The memory 15 may include a volatile memory or a nonvolatile memory.

According to an embodiment of the present disclosure, the memory 15 may store the program 16 for training a virtual defect image generation model based at least on user inputs and generating a virtual defect image by using the trained virtual defect image generation model.

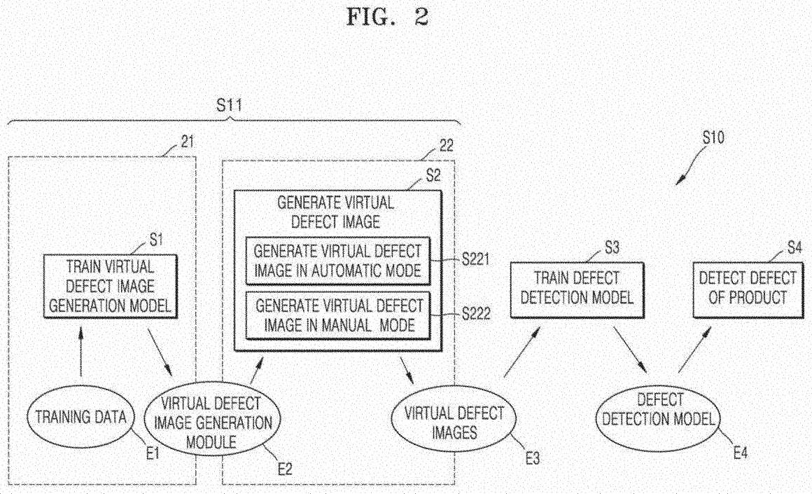

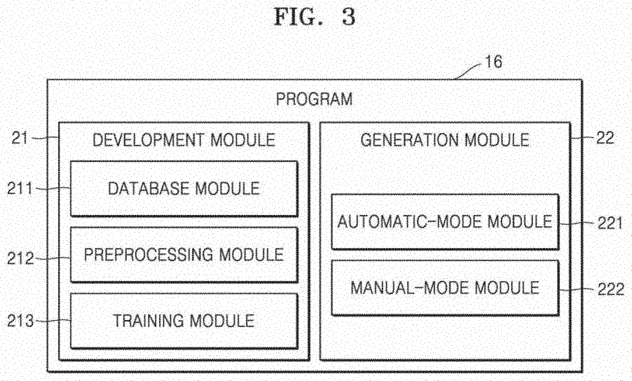

The program 16 is software stored in the memory 15, and may include one or more programs. For example, the program 16 may include a development module 21 for training a virtual defect image generation model, and a generation module 22 for generating a virtual defect image by using the trained virtual defect image generation model as described below with reference to FIGS. 2 and 3, and each of the development module 21 and the generation module 22 may include a plurality of modules, for example, sub-modules.

The display device 13 is a device for visually providing information to a user of the electronic device 10, and may include, for example, a display and a control circuit for controlling the display. According to an embodiment, the display device 13 may include a touch circuitry.

According to an embodiment of the present disclosure, the display device 13 may display screens corresponding to execution of the program 16. The display device 13 may display a graphical user interface (GUI) for receiving user inputs used to train a virtual defect image generation model and generate a virtual defect image.

The input device 14 may receive a command or data to be used by at least one component (e.g., the processor 12) of the electronic device 10 from a source (e.g., the user) external to the electronic device 10. The input device 14 may include, for example, a mouse, a keyboard, a touch screen, a button, a microphone, etc.

FIG. 2 illustrates an example of overall operation S10 including operation S11 of generating a virtual defect image and a usage example thereof, according to an embodiment of the present disclosure.

Referring to FIG. 2, overall operation S10 according to an embodiment of the present disclosure includes operation S1 of training a virtual defect image generation model by using training data E1, operation S2 of generating a virtual defect image by using a trained generation model E2, operation S3 of training a defect detection model by using generated virtual defect images E3 as training data, and operation S4 of detecting a defect of a product by using the trained defect detection model E4.

In FIG. 2, the square blocks may represent, for example, execution by or operations of the processor 12, and the oval blocks may represent, for example, elements (e.g., factors, tools, models, and data) used for the operations or obtained from the operations.

Meanwhile, the term ‘virtual defect image’ as used herein refers to a virtual image of a defective product, which is generated by adding a virtual defect sketch to an image of a normal product. The term ‘virtual defect image generation model’ as used herein refers to an artificial intelligence model that is capable of generating a virtual defect image from a normal image, and may be trained based at least on user inputs with respect to the program 16. The term ‘defect detection model’ as used herein refers to an artificial intelligence model that may be trained by using generated virtual defect images as training data, to detect the presence of a defect in an image of an actual product. The defect detection model may also be generated based at least on user inputs with respect to the program 16.

The electronic device 10 (e.g., the processor 12) according to an embodiment of the present disclosure may perform, for example, operation S1 of training a virtual defect image generation model, operation S2 of generating a virtual defect image, and operation S3 of training a defect detection model. The defect detection model E4 generated as a result of operation S3 may be used, for example, to detect a defect of a product in an actual production line (operation S4).

The program 16 may include the development module 21 for training a virtual defect image generation model from the training data E1 (operation S1) to output the virtual defect image generation model E2, and the generation module 22 for generating a virtual defect image by using the virtual defect image generation model E2 (operation S2) to output the virtual defect images E3. In addition, the program 16 may further include a detection module (or a classification module) (not shown) for training a defect detection model based on the output virtual defect images E3 (operation S3) to output the defect detection model E4. Detailed descriptions of the development module 21 and the generation module 22 will be provided below with reference to drawings.

According to an embodiment, operations S1, S2, S3, and S4 may be based on different artificial intelligence models. For example, an artificial intelligence model (not shown) to be trained as the virtual defect image generation model by using the training data E1 based on user inputs (operation S1) may be embedded in the program 16. In addition, operation S2 of generating a virtual defect image may be performed by using the artificial intelligence model E2 generated as a result of operation S1. In addition, an artificial intelligence model (not shown) to be trained as the defect detection model by using the virtual defect images E3 generated as a result of operation S2 as training data (operation S3) may be embedded in the program 16. In addition, operation S4 of detecting a defect of a product may be performed by using the artificial intelligence model E4 generated as a result of operation S3.

According to an embodiment of the present disclosure, operation S2, performed by the generation module 22, of generating a virtual defect image includes operation S221 of generating a virtual defect image in an automatic mode and operation S222 of generating a virtual defect image in a manual mode.

In operation S221 of generating a virtual defect image in the automatic mode, the virtual defect image is automatically generated through the virtual defect image generation model E2 by using a normal image and information about a preset defect region.

In operation S222 of generating a virtual defect image in the manual mode, the virtual defect image is generated through the virtual defect image generation model E2 by using a normal image and manually marked region information based on an input made by the user for marking a region in which a virtual defect is to be generated.

According to an embodiment, both operation S221 of generating a virtual defect image in the automatic mode and operation S222 of generating a virtual defect image in the manual mode may be performed by using one (identical) virtual defect image generation model E2.

In addition, operation S221 of generating a virtual defect image in the automatic mode and operation S222 of generating a virtual defect image in the manual mode may be not sequentially performed, but may be selectively performed. Therefore, according to user inputs with respect to the program 16 (or the processor 12), a virtual defect image may be generated in the automatic mode or in the manual mode by using one virtual defect image generation model E2. Naturally, virtual defect images may be generated and stored in the automatic mode, virtual defect images may be generated and stored in the manual mode, and then a defect detection model may be trained by using all of the virtual defect images generated in the automatic mode and the manual mode (operation S3).

FIG. 3 illustrates an example of a functional configuration of the program 16 for generating a virtual defect image, according to an embodiment of the present disclosure.

Referring to FIG. 3, the program 16 may include the development module 21 and the generation module 22. As described above with reference to FIG. 2, the development module 21 may train (or develop) a virtual defect image generation model, and the generation module 22 may generate a virtual defect image by using the trained virtual defect image generation module. Although not shown, the program 16 may further include a detection module (or a classification module) for training a defect detection model by using generated virtual defect images.

The development module 21 and the generation module 22 may perform operations based on user inputs. For example, the development module 21 and the generation module 22 may perform a predefined operations or pre-stored (e.g., programmed) operations based on user inputs. Because the development module 21 and the generation module 22 operate based on user inputs, the program 16 may be used according to the user's needs (e.g., for various types of products), and may be used in various fields, rather than in a particular field.

According to an embodiment of the present disclosure, the development module 21 may include a database module 211, a preprocessing module 212, and a training module 213. However, this is merely an example, and at least some of the functions of the respective modules may be integrally configured, or each module may include sub-modules.

The database module 211 may collect and store (or temporarily store) data in order to build a database for training a virtual defect image generation model.

The database module 211 may receive an input of, for example, identification information (e.g., a name) of a product and store the information in the database, load one or more normal images and defect images for training a virtual defect image generation model, and receive an input of information about a defect type and store the information. Also, the database module 211 may label the loaded normal images and defect images according to defect type.

Here, the term ‘normal image’ as used herein refers to an image of an actual product determined to be indefective. The term ‘defect image’ as used herein refers to an image of an actual product determined to be defective. The term ‘defect type’ as used herein refers to the type of a defect that may occur in a product, and a list of defect types may be created according to user inputs. For example, the program 16 (or the processor 12) may receive inputs of defect types from the user, and create and store a list of the defect types as, for example, defect type information. There may be various defect types including, for example, bending, scratch, foreign substance (e.g., stain or contamination), colored foreign substance, and the like.

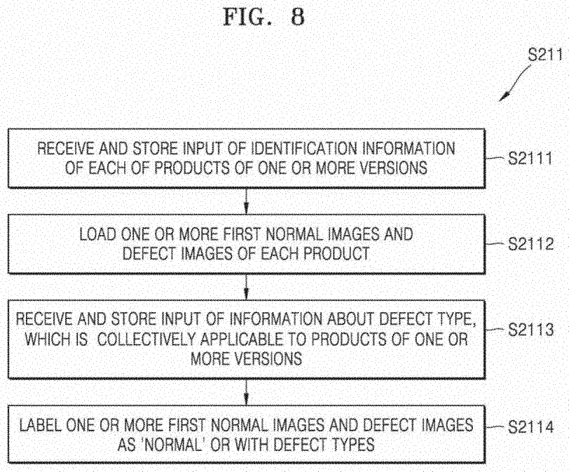

The operation of the database module 211 will be described in detail below with reference to FIG. 8.

The preprocessing module 212 may perform preprocessing on the built database in order to train a virtual defect image generation model.

The preprocessing by the preprocessing module 212 may include, for example, determining a representative image from among one or more loaded normal images, aligning one or more loaded normal images and defect images based on the representative image, and receiving and storing an input of information about defect regions of the representative image in which respective defect types may occur.

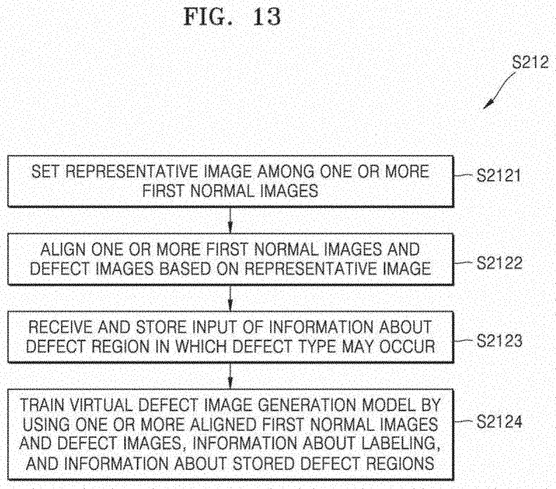

The operation of the preprocessing module 212 will be described in detail below with reference to FIG. 13.

The training module 213 may train a virtual defect image generation model based on the database and the preprocessing. The training module 213 may perform the training by using, for example, the aligned one or more normal images and defect images, information about the labeling, and the information about the defect regions.

According to an embodiment of the present disclosure, the generation module 22 may include an automatic-mode module 221 and a manual-mode module 222. However, this is merely an example, and at least some of the functions of the respective modules may be integrally configured, or each module may include sub-modules.

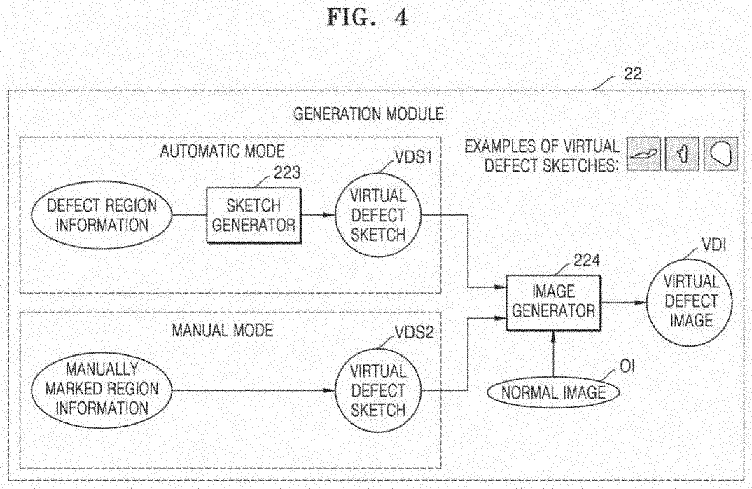

According to an embodiment, the automatic-mode module 221 and the manual-mode module 222 may be different from each other in only function (or mode or algorithm). According to an embodiment, both operation S221 of generating a virtual defect image in the automatic mode and operation S222 of generating a virtual defect image in the manual mode may be performed by using one virtual defect image generation model generated by the development module 21. For example, in the automatic mode, operation S221 of generating a virtual defect image in the automatic mode may be performed by further using a sketch generator 223 (see FIG. 4) stored in the development module 21.

According to an embodiment, the generation module 22 may generate, through the automatic-mode module 221, a virtual defect image by using a normal image, information about a preset defect region, and the virtual defect image generation model E2 that is output from the development module 21.

In addition, the generation module 22 may generate, through the manual-mode module 222, a virtual defect image by using a normal image, an input made by the user for marking a region in which a virtual defect is to be generated, and the virtual defect image generation model E2.

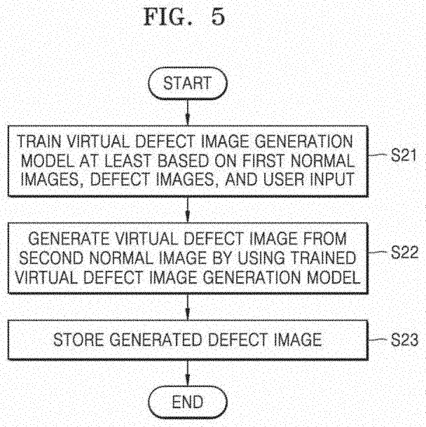

Meanwhile, a second normal image used by the generation module 22 may be the same as or different from a first normal image used by the development module 21. This will be described in detail below with reference to FIG. 5.

Meanwhile, an example of the operation of the generation module 22 in each of the automatic mode and the manual mode will be described below with reference to FIG. 4.

FIG. 4 illustrates an example of operations of the generation module 22 in an automatic mode and a manual mode, according to an embodiment of the present disclosure.

Referring to FIG. 4, the generation module 22 may operate in the automatic mode or the manual mode. The automatic mode and the manual mode are not sequential processes but optional processes. Therefore, according to user inputs with respect to the program 16 (or the processor 12), virtual defect images VDI may be generated in the automatic mode or in the manual mode by using one virtual defect image generation model. Naturally, some of the virtual defect images VDI may be generated and stored in the manual mode, the other virtual defect images VDI may be generated and stored in the automatic mode, and then a defect detection model may be trained by using all of the generated virtual defect images VDI.

According to an embodiment of the present disclosure, one virtual defect image generation model trained by the development module 21 may be used in both the automatic mode and the manual mode. That is, one virtual defect image generation model may generate the virtual defect images VDI in the automatic mode, and may generate the virtual defect images VDI in the manual mode.

According to an embodiment of the present disclosure, in the automatic mode, the sketch generator 223 may generate a virtual defect sketch VDS1 by using preset defect region information and the virtual defect image generation model. The sketch generator 223 may be, for example, one logic, algorithm, artificial intelligence model, or module included in the generation module 22.

In detail, in the automatic mode in operation S2 of generating a virtual defect image, possible defect regions for each defect type may be set with a predetermined (e.g., programmed) shape. For example, in the automatic mode, the user may set, on a normal image of a product, a defect region with a predetermined shape (e.g., a straight line, a quadrangular enclosure, a circular enclosure, a quadrangular area, or a circular area). The set defect region may correspond to the preset defect region information.

In the automatic mode, the generation module 22 (e.g., the sketch generator 223) may generate the virtual defect sketch VDS1 by using the preset defect region information and the trained virtual defect image generation model. The sketch generator 223 may freely or automatically generate the virtual defect sketch VDS1 within a preset defect region (e.g., marked with a straight line, a quadrangular enclosure, a circular enclosure, a quadrangular area, or a circular area), by using the virtual defect image generation model.

The virtual defect sketch VDS1 may be a sketch in which only a virtual defect is drawn without an image of a product. The virtual defect sketch VDS1 may include not only the shape of the defect, but also information about the position and type of the defect. Examples of virtual defect sketches VDS are illustrated in FIG. 4.

Thereafter, an image generator 224 may generate a virtual defect image VDI by adding the virtual defect sketch VDS1 to a normal image OI (e.g., by overlapping or performing synthesis).

According to an embodiment of the present disclosure, in the manual mode, the generation module 22 may generate a virtual defect sketch VDS2 by using manually marked region information based on an input made by the user for marking (i.e., sketching) a region in which a virtual defect is to be generated, and the virtual defect image generation model used in the automatic mode. In the manual mode, because the user sketches a region in which a virtual defect is to be generated by himself/herself, it is unnecessary to preset defect region information as in the automatic mode. Accordingly, in the manual mode, defect region information may not be used.

In addition, in the manual mode, because the virtual defect sketch VDS2 corresponding to a manually marked region that is sketched by the user is generated, the sketch generator 223 is not required. Accordingly, the sketch generator 223 may not be used in the manual mode.

Meanwhile, when the user sketches a manually marked region, the user may specify a defect type, which is the type of a defect to be generated in the manually marked region. Accordingly, the manually marked region information may include, for example, defect type information, or may be linked or matched with the defect type information.

In the automatic mode, the generation module 22 may generate the virtual defect sketch VDS2 corresponding to the manually marked region information by using the manually marked region information and the virtual defect image generation model. The virtual defect sketch VDS2 may be a sketch in which only a virtual defect is drawn without an image of a product. The virtual defect sketch VDS2 may include not only the shape of the defect, but also information about the position and type of the defect.

Thereafter, the image generator 224 may generate the virtual defect image VDI by adding the virtual defect sketch VDS2 to the normal image OI (e.g., by overlapping or performing synthesis). The operation of the image generator 224 may be common in the automatic mode and the manual mode.

FIG. 5 illustrates an example of an operation, performed by the electronic device 10, of generating a virtual defect image, according to an embodiment of the present disclosure. The operations of FIG. 5 may be performed by the processor 12 via the program 16.

Referring to FIG. 5, in operation S21, the processor 12 may train a virtual defect image generation model based at least on first normal images and defect images of a product, and a user input, through the development module 21. In operation S22, the processor 12 may generate a virtual defect image from a second normal image by using the trained virtual defect image generation model, through the generation module 22. In operation S23, the processor 12 may store, in the memory 15, the virtual defect image generated through the generation module 22. The stored virtual defect image may be used as training data to train, for example, a defect detection model.

The first normal images used in operation S21 of training a generation model (or by the development module 21) may be the same as or different from the second normal image used in operation S22 of generating a virtual defect image (or by the generation module 22).

For example, in operation S21, the development module 21 needs the first normal image of the product and the defect image of the product in order to train the virtual defect image generation model. Accordingly, when a sufficient number of normal images and defect images of the product is obtained (e.g., several to several tens of images, but not limited thereto), the normal images of the product may be used as the first normal images by the development module 21.

In contrast, in operation S22, the generation module 22 does not need defect images. The generation module 22 is for newly generating a complete virtual defect image (i.e., a virtual defect image) from a normal image (i.e., a second normal image) by using a virtual defect image generation model. Accordingly, the second normal image used by the generation module 22 does not have to be identical to the first normal images loaded by the development module 21.

Hereinafter, the term ‘first normal image’ refers to a normal image used as training data in operation S21 of training a generation model (or by the development module 21). Hereinafter, the term ‘second normal image’ refers to a normal image, which is the basis of generation of a virtual defect image in operation S22 of generating a virtual defect image (or by the generation module 22).

According to an embodiment, a first normal image and a second normal image may be identical to each other. In this embodiment, the product in the first normal image and the product in the second normal image are naturally the same as each other.

According to another embodiment, different first and second normal images of the same products may be used. That is, among a plurality of normal images of products of the same type and version, different normal images may be used as a first normal image and a second normal image, respectively.

According to another embodiment, when there are a first product and a second product, which are of the same type in a broad sense but have different detailed characteristics (e.g., standard or version), a normal image of the first product may be used as a first normal image, and a normal image of the second product may be used as a second normal image. Accordingly, in order to generate a virtual defect image of the second product, no or only a few defect images of which are available, a virtual defect image generation model may be trained by using defect images of the first product, the number of which is sufficient, and then a virtual defect image of the second product may be generated from a normal image (i.e., the second normal image) of the second product by using the trained virtual defect image generation model.

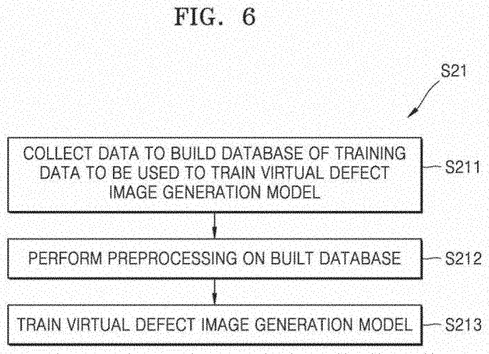

FIG. 6 illustrates an example of an operation, performed by the electronic device 10, of training a virtual defect image generation model, according to an embodiment of the present disclosure. The operations of FIG. 6 may be a detailed example of operation S21, may be performed by the processor 12, and may be performed through the development module 21 of the program 16.

Referring to FIG. 6, in operation S211, the processor 12 may collect and store (or temporarily store) data for a database through the development module 21 (e.g., the database module 211). This is to build a database for training a virtual defect image generation model. Operation S211 will be described in detail below with reference to FIG. 8.

In operation S212, the processor 12 may perform preprocessing on the built database through the development module 21 (e.g., the preprocessing module 212). The preprocessing is for training a virtual defect image generation model. Operation S212 will be described in detail below with reference to FIG. 13.

In operation S213, the processor 12 may train a virtual defect image generation model based on the database and the preprocessing through the development module 21 (e.g., the training module 213).

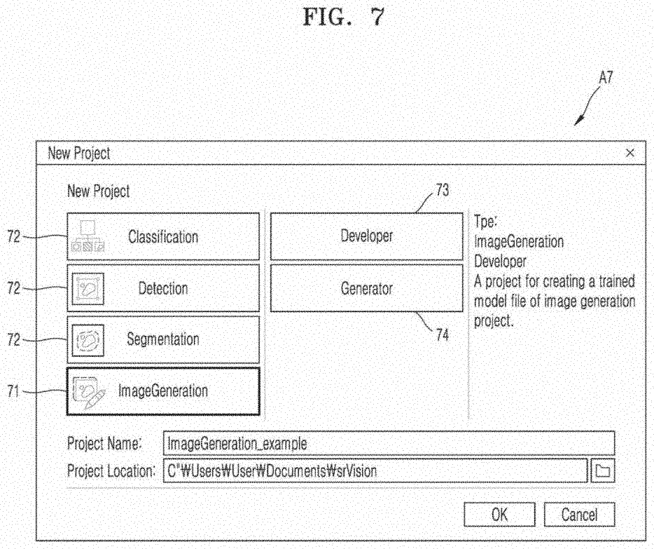

FIG. 7 illustrates an example of a screen A7 of the program 16 for generating a virtual defect image, according to an embodiment of the present disclosure.

Referring to FIG. 7, when the program 16 is executed, the processor 12 may control the display device 13 to display the screen A7 for creating a new project for a virtual defect image generation model. The screen A7 may include an icon 71 for generating a virtual defect image and icons 72 for training a defect detection model by using generated virtual defect images. For example, based on a user input with respect to the icon 71 for generating a virtual defect image, the processor 12 may display a ‘Developer’ icon 73 for entering the development module 21, which is a sub-module of the program 16 (or the processor 12 or the memory 15), and a ‘Generator’ icon 74 for entering the generation module 22, which is another sub-module. The icons 72 for training a defect detection model may correspond to a detection module (or a classification module) (not shown).

When the processor 12 receives a user input with respect to the ‘Developer’ icon 73, operation S1 of training a virtual defect image generation model through the development module 21 may be performed. For example, the development module 21 may create a project for training a virtual defect image generation model. In the project, by performing operation S1 of training a virtual defect image generation model, the development module 21 may output and store the trained virtual defect image generation model E2.

When the processor 12 receives a user input with respect to the ‘Generator’ icon 74, the generation module 22 may perform operation S2 of generating a virtual defect image by using the stored virtual defect image generation model E2. For example, the generation module 22 may create a project for generating a virtual defect image from a normal image (e.g., a second normal image). In the project, the generation module 22 may generate and store one or more virtual defect images E3.

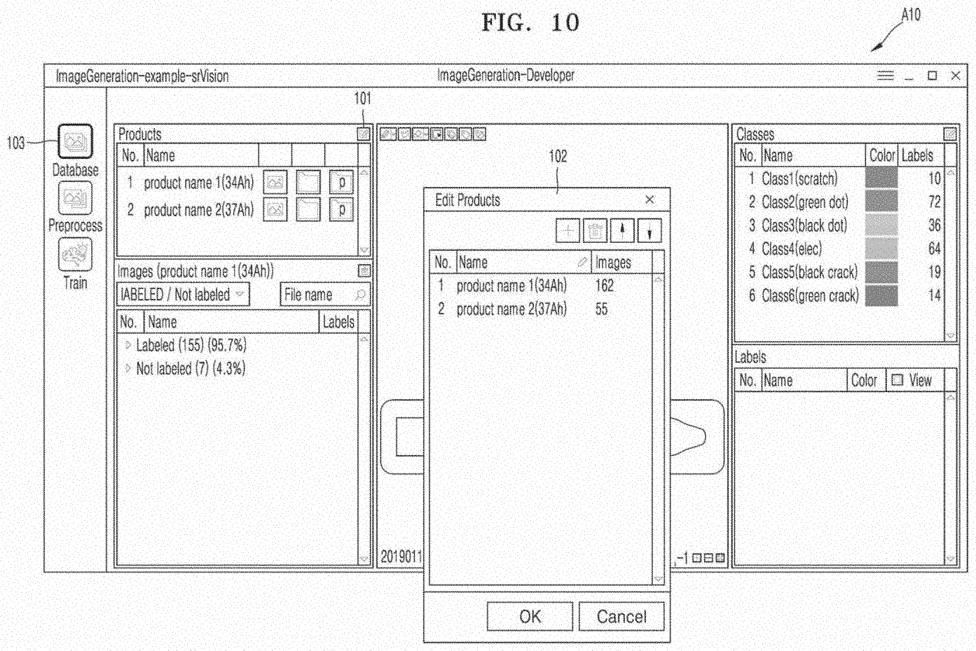

FIG. 8 illustrates an example of an operation, performed by the electronic device 10, of building a database for training a virtual defect image generation model, according to an embodiment of the present disclosure. FIGS. 10 to 12 illustrate examples of screens for building a database according to an embodiment of the present disclosure.

The operations of FIG. 8 may be a detailed example of operation S211 of FIG. 6, may be performed by the processor 12, and may be performed through the development module 21 (e.g., the database module 211) of the program 16.

Referring to FIG. 8, in operation S2111, the processor 12 may receive an input of identification information (e.g., a name) of each of products of one or more versions and store the information, through the development module 21 (e.g., the database module 211). Here, the term ‘products of one or more versions’ may refer to one or more products of the same type in a broad sense but having different detailed characteristics (e.g., standard or version). For example, products of one or more versions may be products having similar shapes, colors, and types of possible defects.

For example, a project does not need to train a virtual defect image generation model based on images (i.e., first normal images and defect images) of products of the same type and version. The project may train one virtual defect image generation model based on products of the same type but different from each other in detailed standard and version.

Accordingly, in operation S2111, the processor 12 may store identification information for each of products of one or more versions to be distinguished from each other.

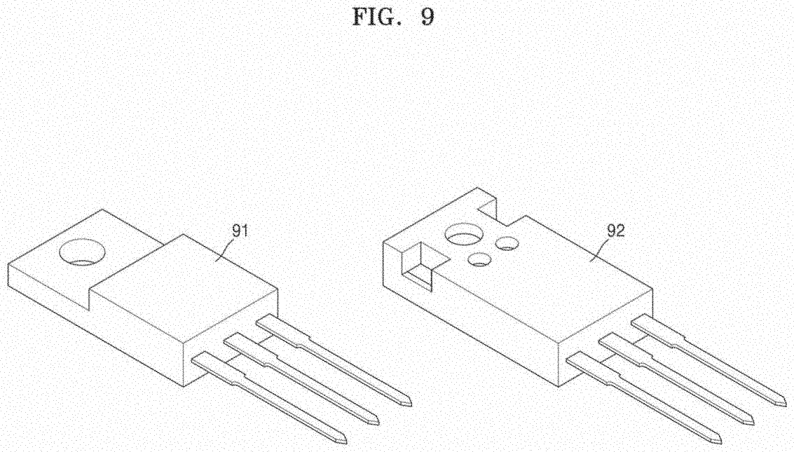

FIG. 9 illustrates examples of products of one or more versions. Referring to FIG. 9, the project may use images of a first transistor 91, which is a first product (i.e., first normal images and defect images), and images of a second transistor 92, which is a second product, to train a virtual defect image generation model.

Referring to FIG. 10, a screen A10 is for receiving an input of identification information (e.g., a name) for each of products of one or more versions. For example, when a user input with respect to an icon 101 for editing a list of products to be used for training is received, the processor 12 may display (e.g., overlay) an edit window 102 for adding or removing one or more products, changing a display order of the products, or modifying identification information (e.g., names) of the products. Referring to the edit window 102, for example, the first product may be a 34-Ah battery and the second product may be a 37-Ah battery.

According to an embodiment, when one virtual defect image generation model is trained in one project by using images of products of a plurality of versions as described above, the performance of the model may be better than when the virtual defect image generation model is trained by using images of a product of one type.

In addition, for example, when a sufficient number (e.g., tens or more) of normal images and defect images of a first product is secured but normal images and defect images of a second product are insufficiently secured, the above-described function may be usefully used to generate a defect detection model for the second product. Naturally, it is also possible to train a virtual defect image generation model based on only the images of the first product and generate a virtual defect image of the second product from a normal image of the second product by using the virtual defect image generation model. However, for example, a virtual defect image of the second product may be obtained with better quality, by training a model based on both the first product and the second product and generating a virtual defect image of the second product from a normal image of the second product by using the model.

According to an embodiment, the effect of training may be improved by adding, to one project, products of a plurality of versions and having similar shapes, colors, and defect types.

Meanwhile, in screens A10, A11, and A12 for building a database, a database icon 103 may be highlighted.

Referring back to FIG. 8, in operation S2112, the processor 12 may load one or more first normal images and defect images of each of the products of one or more versions, through the development module 21 (e.g., the database module 211). The loading may include input and storing based on a user input. As described above, the term ‘first normal image’ may refer to a normal image used to train a virtual defect image generation model. As described above, the term ‘normal image’ refers to an image of an actual product determined to be indefective. As described above, the term ‘defect image’ refers to an image of an actual product determined to be defective.

When a first product and a second product of the same type but different in detail characteristics are added, the processor 12 may receive one or more first normal images and defect images of the first product and one or more first normal images and defect images of the second product, based on a user input, through the program 16.

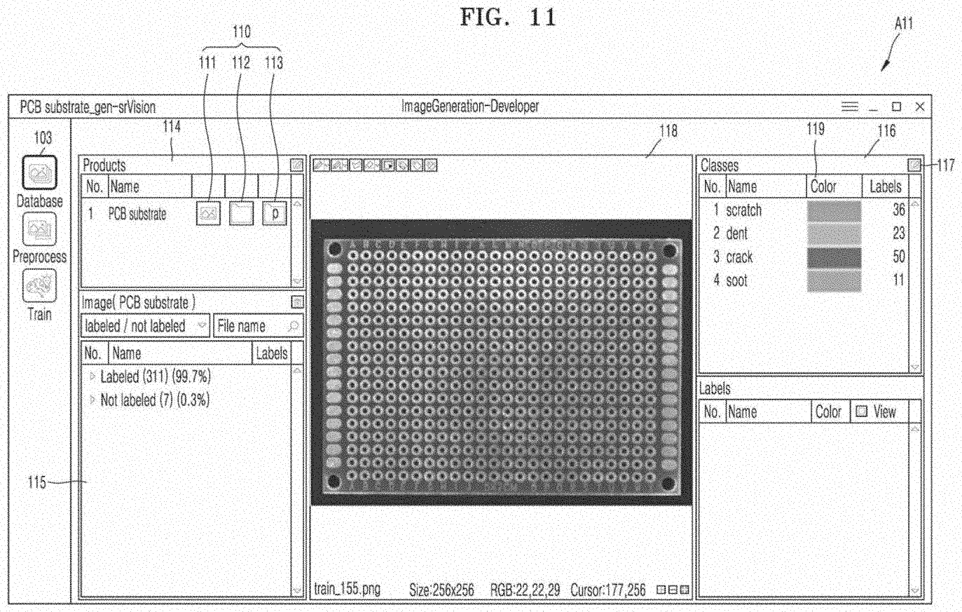

For example, referring to FIG. 11, an example of the screen A11 for building a database is illustrated. For convenience of description, screens for training a virtual defect image generation model based on only products of one version (e.g., printed circuit board (PCB) substrates) in a project will be described with reference to FIG. 11.

The screen A11 may include a product area 114 in which “PCB substrate” is displayed as an example of identification information of a product. When a second product other than “PCB substrate” is registered or added, identification information of the second product (e.g., “PCB substrate 2”) is displayed below “PCB substrate” in the product area 114, and thus a product list may be displayed. The second product may be, for example, a PCB substrate having detailed characteristics or a standard different from that of the first product.

The product area 114 may include icons 110 for loading images of each product (i.e., one or more first normal images and defect images of the product) based on a user input. For example, the icons 110 for loading images may include a first icon 111, a second icon 112, and a third icon 113. The processor 12 may load an image based on a user input with respect to the first icon 111, may load images from a folder based on a user input with respect to the second icon 112, and may load a pre-stored image from a project (e.g., another project) based on a user input with respect to the third icon 113.

The loaded images may include one or more first normal images and one or more defect images. Preferably, for the quality of training, a plurality of (e.g., tens or more of) first normal images and defect images may be loaded, respectively. However, the plurality of defect images may be insufficient to be directly used as training data for the defect detection model E4.

The screen A11 may include an image list area 115 for displaying a list of loaded images or information about the loaded images. Although not shown in FIG. 11, the image list area 115 may display a list of loaded images. When a second product other than “PCB substrate” is registered, for example, only an image list of the currently activated product may be displayed in the image list area 115. The currently activated product may be, for example, a product selected in the product area 114.

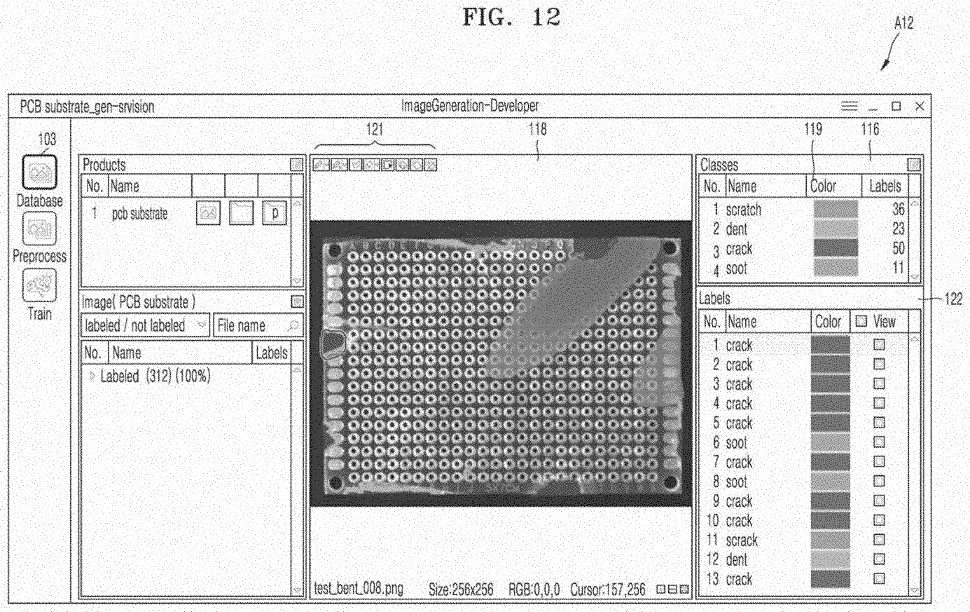

Meanwhile, the image list area 115 of FIG. 11 displays information about labeling of currently loaded images, and a detailed description of the labeling will be provided below with reference to FIG. 12.

For example, in the screen A11, an image selected (or activated) from the list of loaded images in the image list area 115 may be displayed on an image area 118. A normal image or a defect image may be displayed in the image area 118.

Referring back to FIG. 8, in operation S2113, the processor 12 may receive an input of information about a defect type, which is collectively applicable to the products of one or more versions, and store the information, through the development module 21 (e.g., the database module 211).

For example, referring to FIG. 11, the screen A11 may include a defect type area 116 showing information about defect types. As described above, the term ‘defect type’ may refer to the type of a defect that may occur in a product. The defect type may be set or generated based on a user input. In the present disclosure, generating certain information (e.g., a defect type, a defect region, etc.) may include generating and storing identification information corresponding to the certain information, which may be identified by the processor 12 in response to a user input for generating the certain information through a user interface (UI).

When a defect type is generated based on a user input, the processor 12 may store information about the defect type. The information about the defect type may include, for example, an identification number of the defect type, an identification name of the defect type, an identification color 119 of the defect type, and the like, and may be input based on a user input.

Referring to the defect type area 116, the product identified as “PCB substrate” may include defect types ‘scratch’, ‘dent’, ‘crack’, and ‘soot’. However, the defect type is not limited thereto, and may be variously set based on a user input according to the characteristics of the product. For example, although not shown in the present embodiment, for example, ‘dent’, ‘colored foreign substance’, and the like may be set as defect types. For example, the defect type ‘dent’ may be applicable to a product such as a blade. The defect type ‘colored foreign substance’ may correspond to, for example, a stain or contamination due to leakage of a particular adhesive or electrolyte. However, the present disclosure is not limited thereto.

When a second product is additionally registered in the project in addition to the first product (identification information: “PCB substrate”), the defect types need to be collectively applicable to the first product and the second product. For example, only defects, for example, scratch, dent, crack, and soot, that may also occur in the second product (e.g., PCB substrate 2) may be added.

According to an embodiment, by classifying defect types according to shape, color, and the like, training performance may be improved.

Meanwhile, the meaning of ‘identification color’ of a defect type may be different from the meaning of ‘color of a defect’. ‘Color of a defect’ may refer to the actual color of a particular foreign substance in a defect image. ‘Identification color’ may be set based on a user input. The identification color 119 of a defect type may be used to indicate which defect type each virtual defect image includes, when the virtual defect image is generated through the generation module 22.

For example, the defect type area 116 may include a defect type edit icon 117. Upon receiving a user input with respect to the defect type edit icon 117, the processor 12 may display (overlay) an edit window (not shown) for adding or removing a defect type, changing a display order of defect types, modifying an identification name of a defect type, or changing an identification color of a defect type. That is, the user may edit information about a defect type through the defect type edit icon 117.

Referring back to FIG. 8, in operation S2114, the processor 12 may label the loaded first normal images and defect images as ‘Normal’ or with defect types, through the development module 21 (e.g., the database module 211).

For example, referring to FIG. 12, the screen A12 is an example of a screen for performing labeling on an image displayed in the image area 118.

The image area 118 may display labeling tool icons 121. For example, the user may perform labeling on each of the loaded images, and when the image displayed in the image area 118 is a normal image, the user may label the image as ‘Normal’ by using the labeling tool icons 121. In addition, when the image displayed in the image area 118 is a defect image, the user may select a defect type of the image, and label the image by marking (e.g., by using the input device 14) a region in which a defect of the defect type occurs on the image by using the labeling tool icons 121.

For example, when the image displayed in the image area 118 has a defect type ‘crack’, the user may select a corresponding defect type (i.e., ‘crack’) in the defect type area 116 and make a user input for marking or painting a region in which a crack defect occurs on the displayed image by using the labeling tool icons 121. In this case, the marked or painted region (i.e., the region in which the defect occurs) may appear in a color corresponding to the identification color 119 of the defect type. For example, when the identification color 119 of the defect type ‘crack’ is red, the region in which the crack defect occurs in the image may appear in red when the user marks or paints the region. However, the present disclosure is not limited thereto.

According to an embodiment, a single defect image may include a plurality of defect types. In a labeling information area 122, labeling information (e.g., information about a defect type or information indicating a normal image) of a displayed image may be displayed.

For example, when a single defect image is labeled with a plurality of defect types, information about all of the plurality of defect types may be displayed in the labeling information area 122.

For example, when the labeling operation is performed, the processor 12 may match and store each image with labeling information (e.g., information about a defect type, information about a region in which a corresponding defect type occurs, or information indicating a normal image).

As described above with reference to FIGS. 8 to 12, a database for training a virtual defect image generation model may be built (operation S211). In screens A10, A11, and A12 for building a database, the database icon 103 may be highlighted.

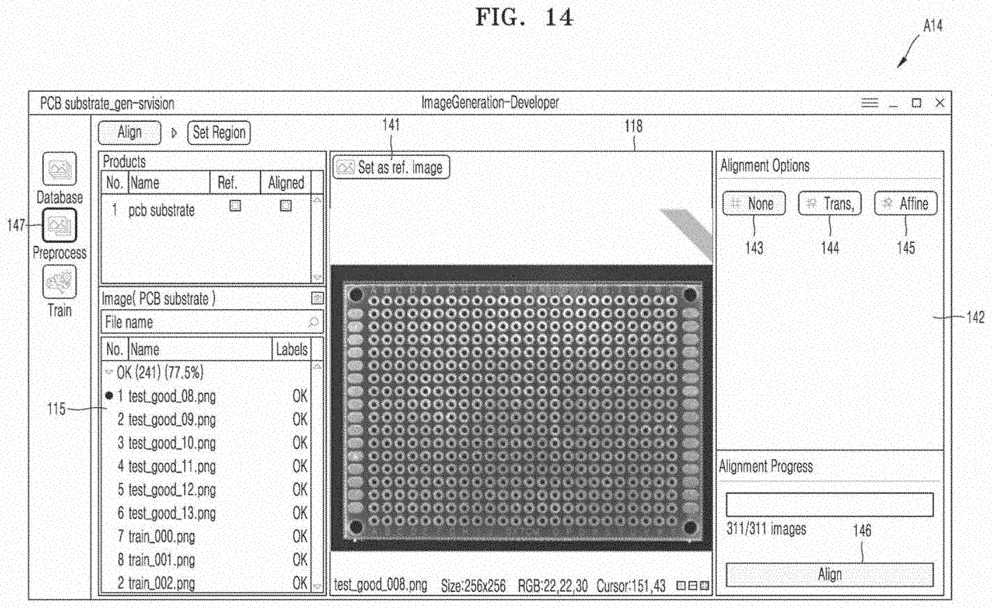

FIG. 13 illustrates an example of an operation, performed by the electronic device 10, of performing preprocessing on a database for training a virtual defect image generation model, according to an embodiment of the present disclosure. FIGS. 14 to 18 illustrate examples of screens for performing preprocessing according to an embodiment of the present disclosure.

The operations of FIG. 13 may be a detailed example of operation S212 of FIG. 6, may be performed by the processor 12, and may be performed through the development module 21 (e.g., the preprocessing module 212) of the program 16.

Referring to FIG. 13, in operation S2121, the processor 12 may set a representative image among one or more loaded first normal images, through the development module 21 (e.g., the preprocessing module 212). The representative image may be a reference of alignment of the images (operation S2122), and may be used to set a defect region in which each defect type may occur (operation S2123). The representative image may be set from among normal images (i.e., first normal images).

For example, referring to FIG. 14, a screen A14 for setting a representative image is illustrated. For example, normal images (i.e., images labeled as ‘Normal’) may be collected and displayed in the image list area 115 by using stored labeling information. Based on a user input for selecting one normal image from a list of the normal images, the selected normal image may be displayed in the image area 118. For example, based on a user input with respect to a representative image setting icon 141, a normal image (e.g., test_good_008.png) displayed in the image area 118 may be set and stored as a representative image.

Referring back to FIG. 13, in operation S2122, the processor 12 may align loaded and labeled first normal images and defect images based on the set representative image, through the development module 21 (e.g., the preprocessing module 212). For example, images listed in the image list area 115 may be aligned.

According to an embodiment, the alignment may be performed in one of three types. The three types include a none type, a trans type, and an affine type. The none type is an option of not performing alignment. The trans type is an option of performing alignment through translation on an image. The affine type is an option to perform alignment by rotating, resizing, and translating an image.

For example, referring to FIG. 14, the screen A14 may include an alignment option area 142. In the alignment option area 142, a non-alignment icon 143 for skipping alignment, a trans icon 144 for performing trans-type alignment, and an affine icon 145 for performing affine-type alignment may be displayed.

Upon receiving a user input with respect to the non-alignment icon 143, the processor 12 may not perform alignment of the plurality of labeled images and proceed to the next operation. For example, when all of the plurality of labeled images are well aligned, the user may select the non-alignment icon 143.

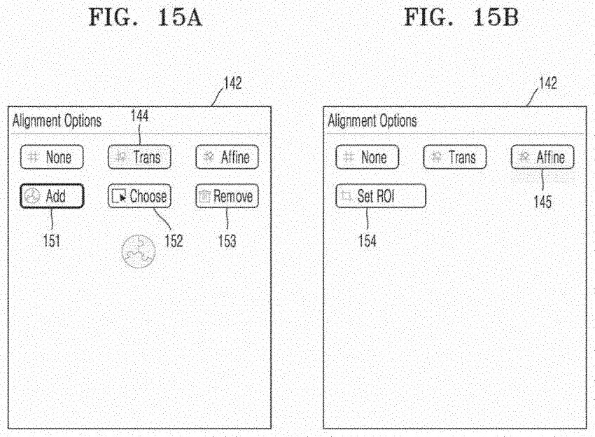

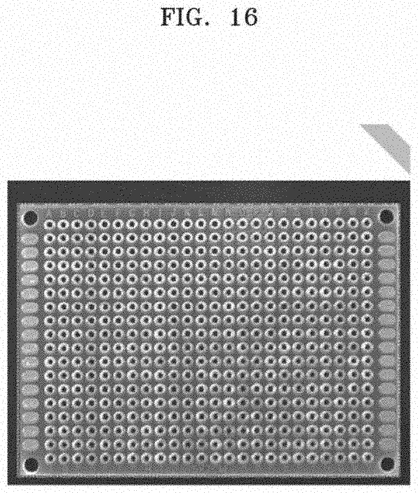

Referring to (a) of FIG. 15, when the trans icon 144 is selected in the alignment option area 142, a part to be used as a reference of alignment or position information of the part may be indicated on the representative image. Preferably, the number of parts (or pieces of position information of parts) may be set to three. However, the present disclosure is not limited thereto. For example, when the trans icon 144 is selected in the alignment option area 142, a part (or the position of the part) may be selected through an ‘Add’ button 151 and a ‘Choose’ button 152, and a selected part may be removed through a ‘Remove’ button 153. For example, a part (or the position of the part) may be selected, as indicated by the dash-dotted line in FIG. 16.

when performing the trans-type alignment, the processor 12 may identify a part (or position information of the part) in the plurality of images, and align the plurality of images by performing translation on the plurality of images according to the position information of the identified part, to correspond to the arrangement of the representative image. The trans-type alignment may be applicable when all images have the same size.

Referring to (b) of FIG. 15, when the affine icon 145 is selected in the alignment option area 142, a region of the product may be set on the representative image. For example, when the affine icon 145 is selected in the alignment option area 142, the region in which the product is present may be set as a region of interest (ROI) through a ‘Set ROI’ button 154. For example, the ROI in which the product is present may be selected, as indicated by the dash-dotted line in FIG. 16.

When performing the affine-type alignment, the processor 12 may transform at least a portion of each of the plurality of images such that a region of the image in which the product is present has the same shape as that of the ROI.

Referring to FIG. 14, when the selection of the alignment option in the alignment option area 142 is completed, the processor 12 may perform alignment on all labeled images of the corresponding product based on a user input with respect to an ‘Align’ icon 146.

When a plurality of products are added to the project, the processor 12 may perform the alignment process for each product based on a user input. Different alignment options may be applied to the respective products.

The processor 12 may display, through the program 16, a separate indication on an image on which alignment is not properly performed, and the image on which the alignment is not properly performed may be removed based on a user input.

Meanwhile, in screens A14, A17, and A18 for performing preprocessing, a ‘Preprocess’ icon 147 may be highlighted.

Referring back to FIG. 13, in operation S2123, the processor 12 may receive an input of information about a defect region in which each defect type may occur, on the set representative image, and store the information, through the development module 21 (e.g., the preprocessing module 212).

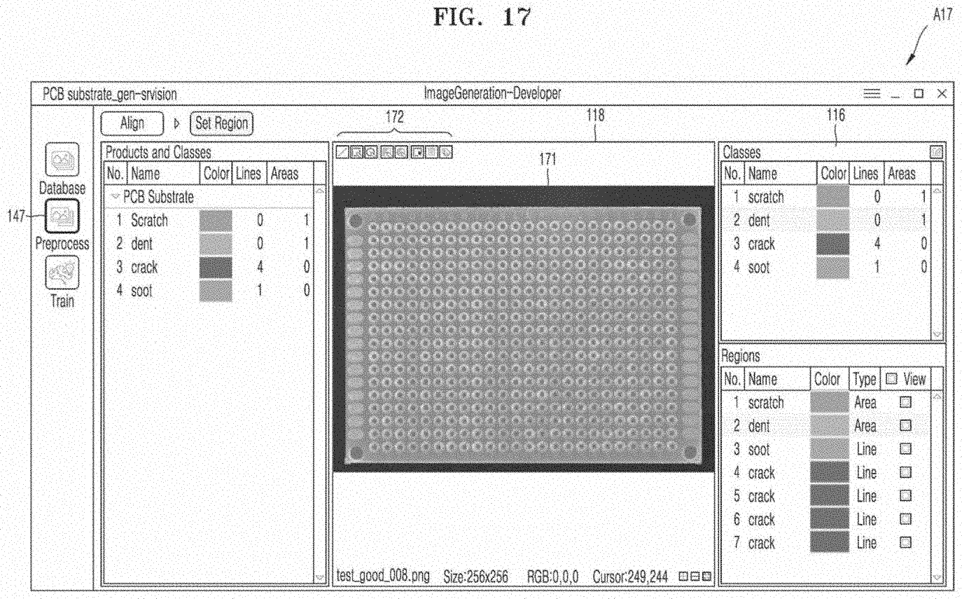

For example, referring to FIG. 17, the processor 12 may receive a user input for setting a defect region on a set representative image 171 through the screen A17. For example, in an operation of setting a defect region, defect region setting icons 172 for setting a defect region on the representative image 171 may be displayed in the image area 118.

For example, after selecting an arbitrary defect type in the defect type area 116, the user may mark a region in which a defect of the selected defect type may occur, on the representative image 171 by using the defect region setting icons 172. The defect region setting icons 172 allow the user to mark a defect area with a predetermined shape (e.g., a straight line, a quadrangular enclosure, a circular enclosure, a quadrangular area, or a circular area).

The term ‘defect region’ may refer to a region in which a defect corresponding to a certain defect type may occur. A defect region is different from a region in which a defect occurs, which is indicated for labeling. In a labeling operation, regions in which respective defects occur are indicated on each defect image. However, indicating a defect region may be indicating each region in which each defect type may occur on a representative image.

For example, when a dent defect may occur in the entire region of a product having a quadrangular shape (e.g., a PCB board), the user may perform the following user input through a UI of the program 16. The user may select the defect type ‘dent’ in the defect type area 116, select one icon for drawing a quadrangular area from among the defect region setting icons 172, and mark a defect region on the entire region (i.e., the quadrangular region) of the product in which a dent defect may occur, on the representative image 171. The defect region marked on the representative image may be in an identification color (e.g., yellow) of the defect type ‘dent’.

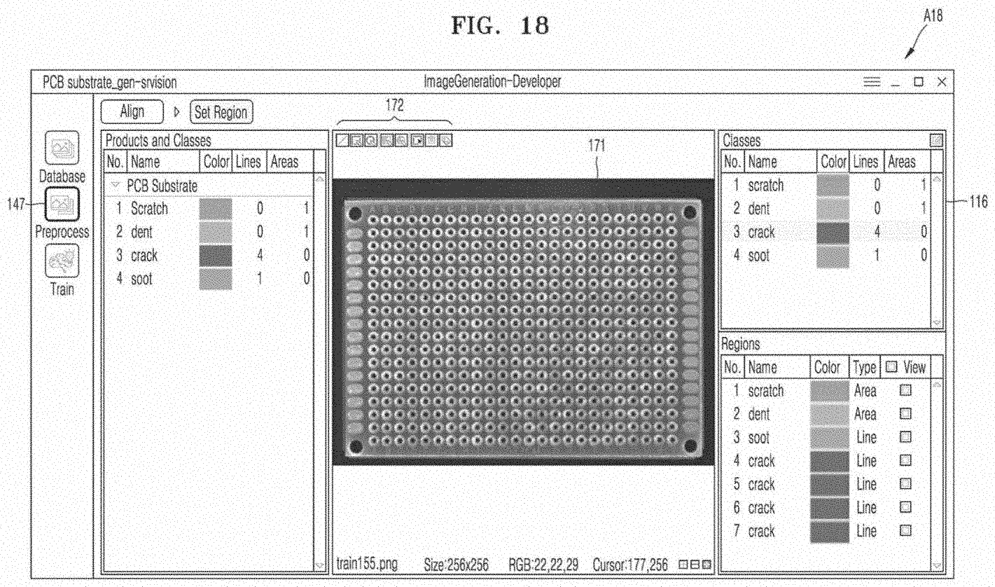

As another example, referring to the screen A18 of FIG. 18, when a crack defect may occur at a corner of a product (e.g., a PCB substrate), and a boundary of a corner of the product is a straight line, the user may perform the following user input through the UI of the program 16.

The user may select the defect type ‘crack’ in the defect type area 116, select one icon for drawing a straight line from among the defect region setting icons 172, and mark a defect region on the corner (i.e., a straight-line region) of the PCB substrate in which a crack defect may occur, on the representative image 171. As illustrated in FIG. 18, a plurality of defect regions may be set for one defect type (e.g., ‘crack’). The defect region marked on the representative image may be in an identification color (e.g., red) of the corresponding defect type (e.g., ‘crack’).

Referring back to FIG. 13, in operation S2124, the processor 12 may train, through the development module 21 (e.g., the training module 213), a virtual defect image generation model by using one or more aligned first normal images and defect images, labeling information, and information about defect regions. Operation S2124 may corresponding to operation S213 of FIG. 6.

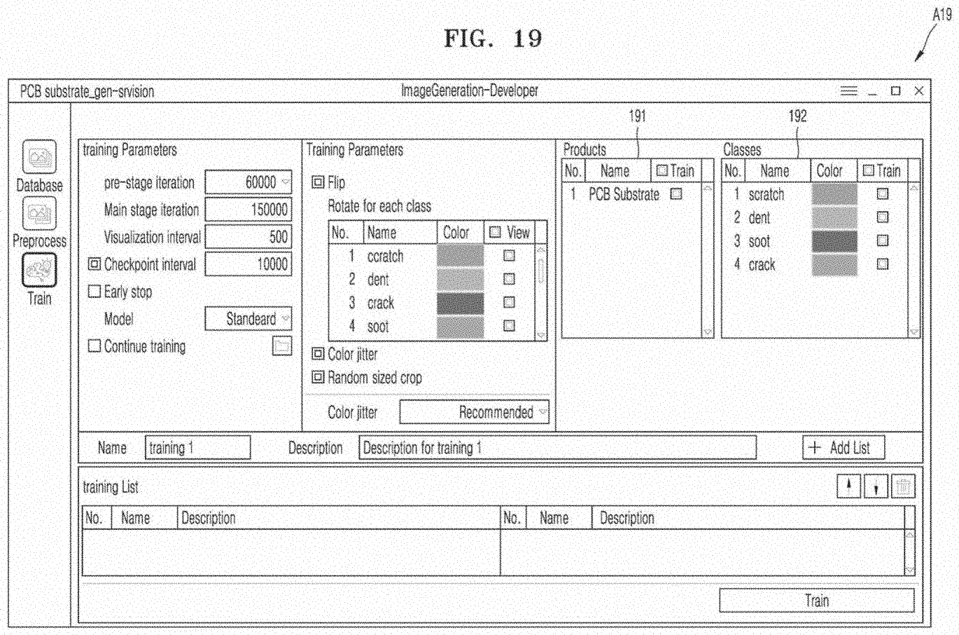

For example, referring to FIG. 19, a screen A19 for performing training is illustrated. Various training parameters may be input through the screen A19.

Referring to the screen A19, according to an embodiment, training may include two stages, i.e., a pre-stage and a main stage. The pre-stage includes iterations in each of which preprocessing is performed before the training, and the number of iterations may be set. The number of iterations of training in the main stage may also be set based on a user input.

Whenever the number of completed iterations of training reaches multiples of a visualization interval, a sample image generated by a trained model may be provided. The visualization interval may also be input by the user.

According to an embodiment of the present disclosure, at least one product to be used for training may be selected in a product area 191 displayed on the screen A19 for training.

According to this function, after collection of data (operation S211, see FIG. 6) and preprocessing (operation S212) are performed at once on products of a plurality of versions (e.g., a first product, a second product, etc.), a plurality of models may be trained (or generated) while selecting products to be used for training from among the products of a plurality of versions in a training operation (operation S213). Through this function, it is also possible to select a model having the best performance among the plurality of models and use the selected model as a virtual defect image generation model.

Likewise, at least one defect type to be used for training may be selected in a defect type area 192 displayed on the screen A19 for training. According to the selection of the defect type, various versions of models may be trained.

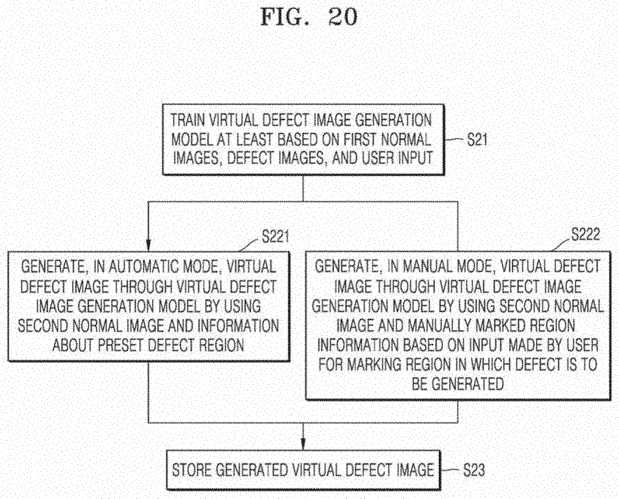

FIG. 20 illustrates an example of an operation, performed by the electronic device 10, of generating a virtual defect image, according to an embodiment of the present disclosure. The operations of FIG. 20 may be performed by the processor 12 via the program 16.

Referring to FIG. 20, in operation S21, the processor 12 may train a virtual defect image generation model based at least on first normal images, defect images, and a user input, through the program 16 (e.g., the development module 21). This corresponds to the description provided with reference to operation S21 of FIG. 5, and FIG. 6.

In operation S21, the processor 12 may generate a virtual defect image in the automatic mode (operation S221) or in the manual mode (operation S222), based on a user input, through the program 16 (e.g., the generation module 22). For example, in operation S221 of generating a virtual defect image in the automatic mode, the virtual defect image is generated through a virtual defect image generation model by using a second normal image and information about a preset defect region. For example, in operation S222 of generating a virtual defect image in the manual mode, the virtual defect image is generated through the virtual defect image generation model, which is also used in the automatic mode, by using a second normal image and manually marked region information based on an input made by the user for marking a region in which a defect is to be generated. This is described above with reference to FIG. 4, and will be described in detail below with reference to the following drawings.

In operation S23, the processor 12 may store the generated virtual defect image in the memory 15 through the program 16 (e.g., the generation module 22). The stored virtual defect image may be used as training data to train, for example, a defect detection model.

Hereinafter, operation S221 of generating a virtual defect image in the automatic mode and operation S222 of generating a virtual defect image in the manual mode will be described in detail.

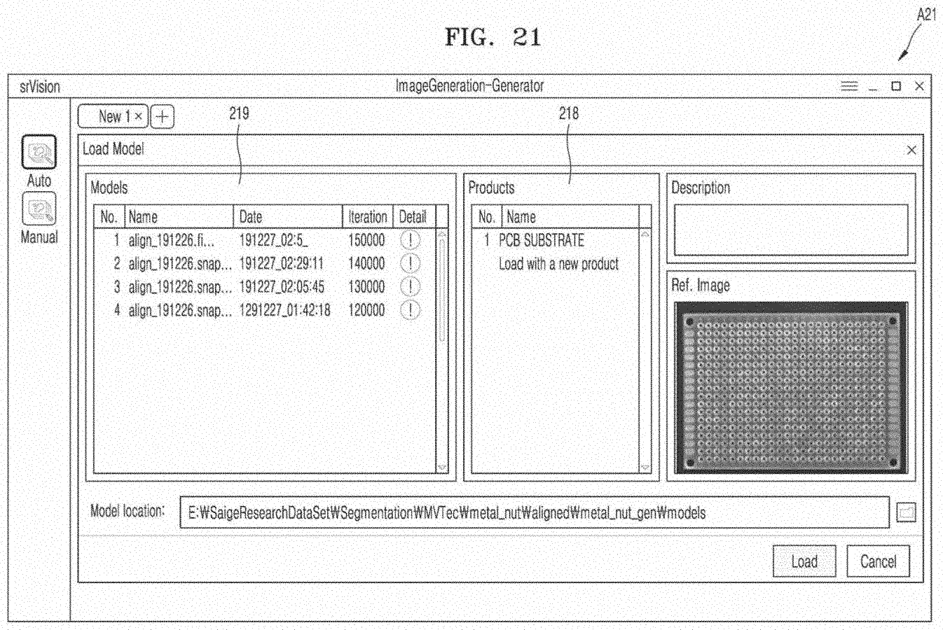

FIGS. 21 to 27 illustrate examples of screens for performing automatic-mode generation according to an embodiment of the present disclosure.

First, in order to generate a virtual defect image by using the virtual defect image generation model generated and stored in operation S21, the processor 12 may receive a user input with respect to the ‘Generator’ icon 74 on the screen A7 of FIG. 7. Based on receiving an user input with respect to the ‘Generator’ icon 74, the processor 12 may enter operation S2 of generating a virtual defect image.

Thereafter, a screen A21 of FIG. 21 may be displayed based on a certain user input for selecting the automatic mode. In the screen A21, a list 219 of various virtual defect image generation models trained and stored in a corresponding project may be displayed. From the list 219 of virtual defect image generation models, a model to be used for generating a virtual defect image may be selected.

In a product area 218, a list of products of one or more versions that have been used for training the selected model may be displayed. A product to be used for generating a virtual defect image may be selected from among the products one or more versions displayed in the product area 218.

When a user input is made with respect to a certain icon (e.g., “Load with a new product”) in the product area 218, a virtual defect image of a new product, which has not been used for the training, may be generated. For example, the processor 12 may display (e.g., overlay) a window for registering (or adding) a new product based on a user input with respect to the icon.

For example, even when only images of a first product have been used for the training of the virtual defect image generation model, in operation S2 of generating a virtual defect image, a virtual defect image of a second product, which is of the same type as that of the first product but has different detailed characteristics (e.g., version or standard), may be generated from only a second normal image of the second product by using the trained virtual defect image generation model.

Based on the user's selection, information about the selected virtual defect image generation model and a selected product may be loaded into the program 16 (e.g., the generation module 22).

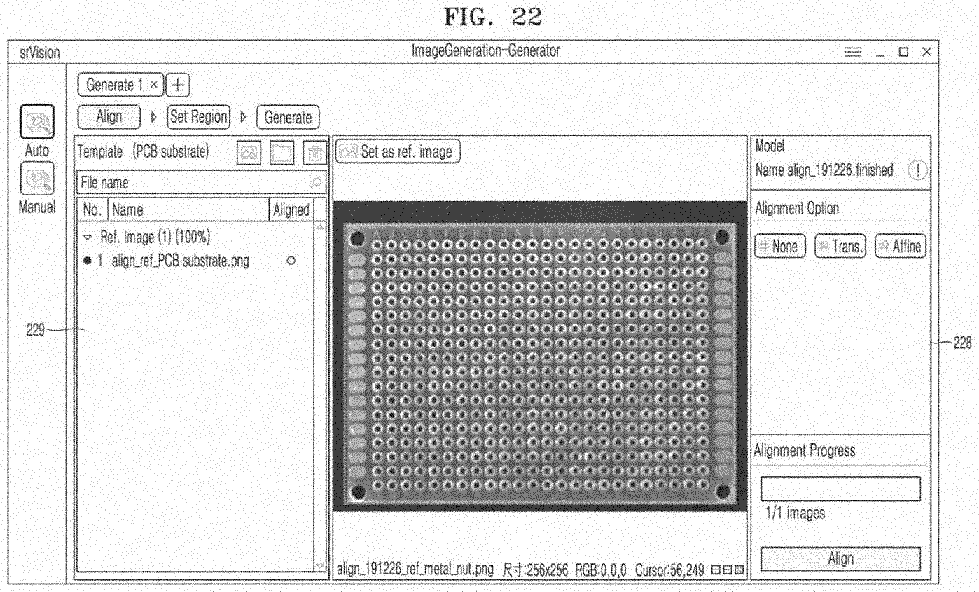

Thereafter, referring to FIG. 22, template images for the selected product, which are used as the basis of generation of a virtual defect image, may be loaded in a template image area 229. The term ‘template image’ refers to a normal image of a selected product, and may be referred to as ‘second normal image’ described above. A single template image may be loaded as illustrated in FIG. 22, but a plurality of template images may also be loaded. For example, a plurality of template images may be used for the diversity of virtual defect images to be generated based on the template images.

When a plurality of template images (i.e., a plurality of second normal images) are loaded, the plurality of template images need to be aligned in order to generate a virtual defect image. When the product that has been used for the training is selected (or loaded), alignment information that has been set in a preprocessing process by the development module 21 may be applied as it is.

On the other hand, when a new product that has not been used for the training is loaded, it may be necessary to set a representative image of one or more template images and perform alignment on the template images in operation S221 of generating a virtual defect image in the automatic mode. For example, the plurality of template images may be aligned to correspond to the arrangement of the representative image (i.e., a representative template image) through an alignment option area 228. The alignment method may correspond to the alignment method described above with reference to FIGS. 14 to 16. Therefore, a description thereof will be omitted.

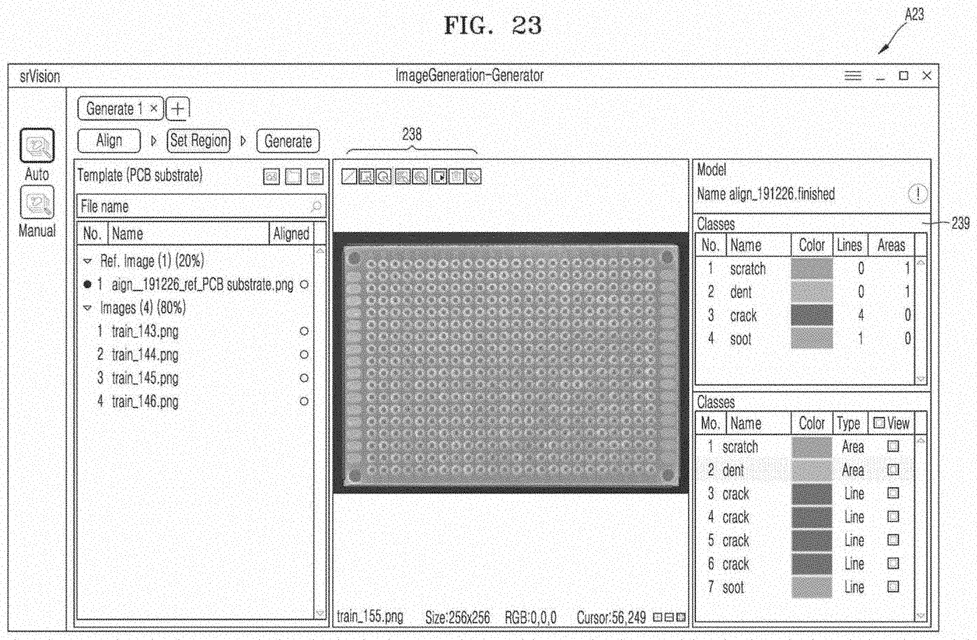

Thereafter, referring to FIG. 23, a defect region, which is a region in which each defect type may occur, may be required for automatic-mode generation performed through a screen A23. That is, defect region information for each defect type may be required. When the product that has been used for the training is selected (or loaded), defect region information that has been set in a preprocessing process by the development module 21 may be applied as it is.

On the other hand, when a new product that has not been used for the training is loaded, it may be necessary to newly set defect region information for a representative image of one or more template images in operation S221 of generating a virtual defect image in the automatic mode. For example, the user may select a defect type in a defect type area 239, and set or mark a defect region in which each defect type may occur, by using defect region setting icons 238.

Meanwhile, in this operation, only a defect region, which may be linked with a defect region set in a process of training the model, may be set. For example, defect regions marked with a straight line and a quadrangular enclosure may be linked with each other. As another example, defect regions marked with a quadrangular area and a circular area may be linked with each other. For example, when a defect region of a particular defect type has been marked with a quadrangular area in the training process (i.e., in a development process), in this operation (i.e., in the automatic-mode generation), a defect region of the particular defect type may be marked with only a quadrangular area or a circular area.

Meanwhile, setting of a defect region may be necessary for the automatic-mode generation. In the automatic mode, the generation module 22 may freely or automatically generate a virtual defect sketch within a defect region, which is set as described above, to overlap or synthesize the virtual defect sketch with a template image. The method of setting a defect region may correspond to the method of setting a defect region described with reference to FIGS. 17 to 18, and thus a detailed description thereof will be omitted.

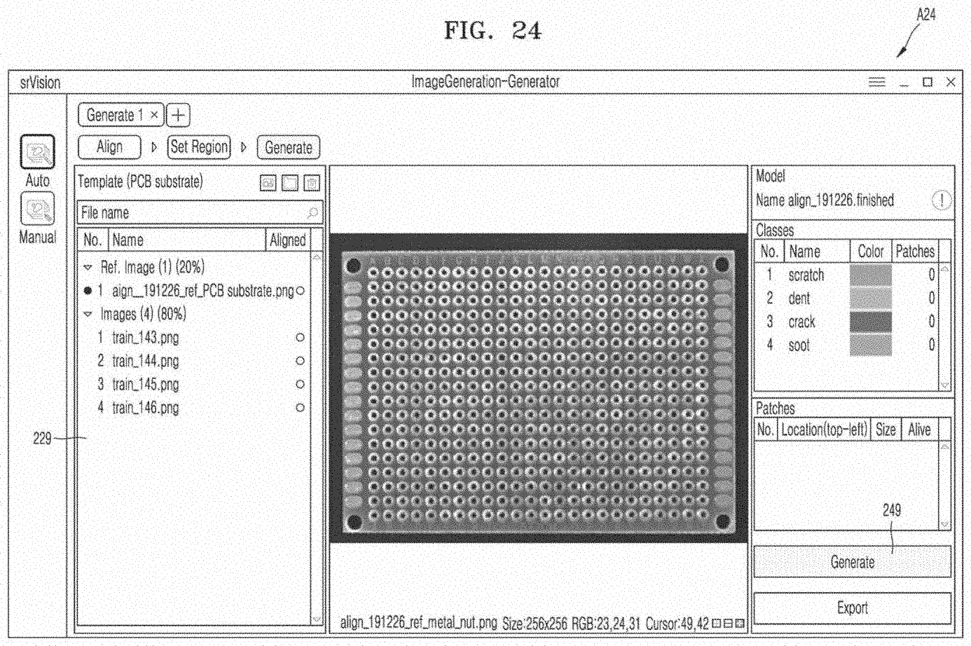

Thereafter, a virtual defect image may be generated in the automatic mode through a ‘Generate’ button 249 of a screen A24 of FIG. 24. Because the operation of generating a virtual defect image in the automatic mode may correspond to the operation of generating a virtual defect image in the automatic mode described with reference to FIG. 4, a detailed description thereof will be omitted and a brief description will be provided.

In the automatic mode, the processor 12 may generate a virtual defect image by using the set defect region information and the virtual defect image generation model (operation S221). For example, the processor 12 may generate a virtual defect sketch by using the set defect region information and the virtual defect image generation model. For example, the virtual defect sketch may be a sketch generated to be freely arranged on a defect region in which a certain defect type may occur. The virtual defect sketch may include, for example, color information, shape information, and arrangement (position) information (e.g., pixel information). Thereafter, the processor 12 may generate a virtual defect image by overlapping or synthesizing the virtual defect sketch with a second normal image (i.e., a template image) loaded in the template image area 229.

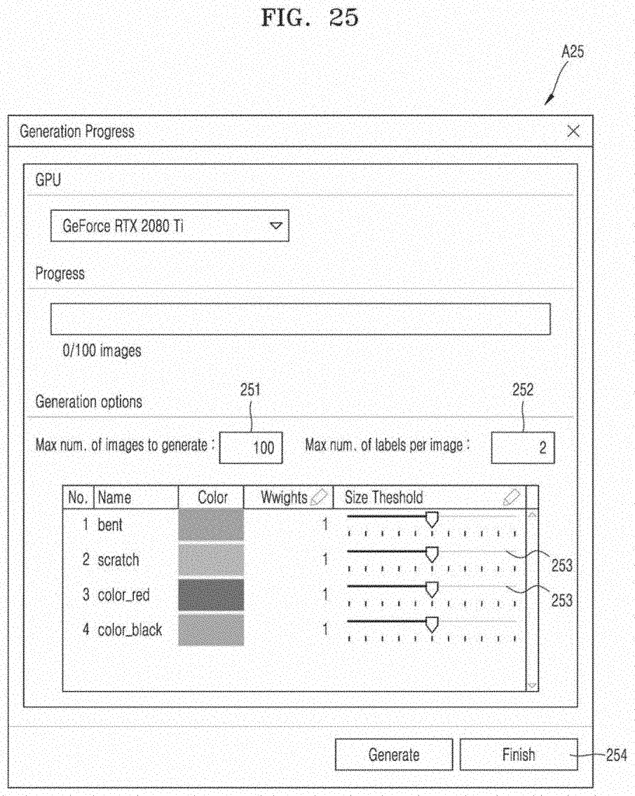

The processor 12 may display a screen A25 of FIG. 25 based on receiving a user input with respect to the ‘Generate’ button 249 of the screen A24. The processor 12 may receive an input of the number of virtual defect images to be generated, through a first input box 251. The processor 12 may receive an input of the maximum number of defects to be generated per image, through a second input box 252. The processor 12 may receive an input of a weight to be used for generation of each defect type. The processor 12 may receive an input of the minimum size of a defect to be generated for each defect type through sliders 253. Upon receiving a user input with respect to a ‘Generate’ button 254, the processor 12 may start to generate a virtual defect image.

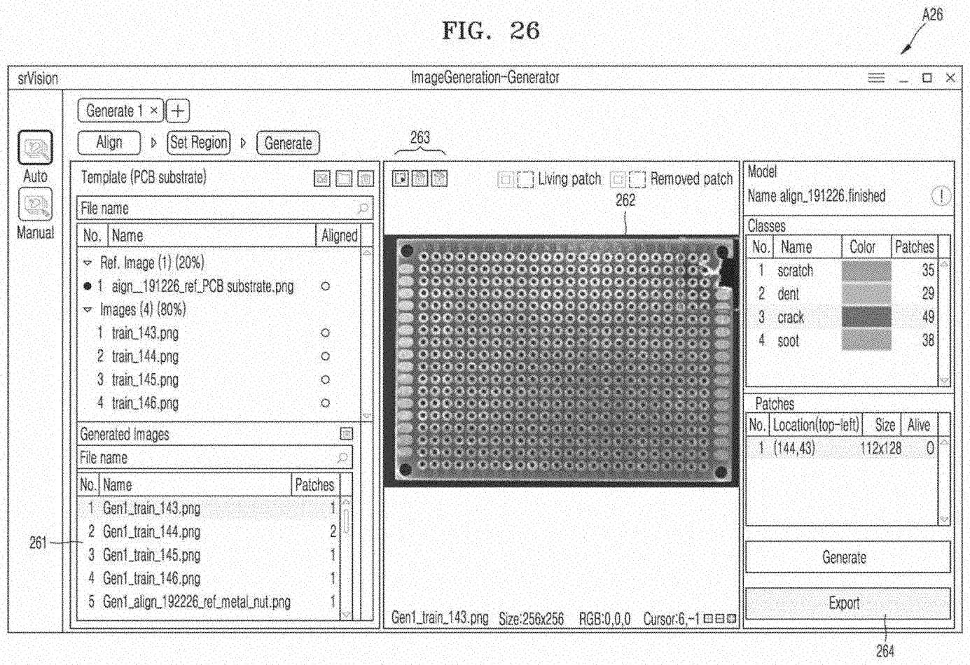

Thereafter, generated virtual defect images may be displayed on a screen A26 of FIG. 26. A list of generated virtual defect images may be displayed in a generated image list area 261 of the screen A26. When one virtual defect image displayed in the generated image list area 261 is clicked, the corresponding virtual defect image may be displayed in an image area 262. On the displayed virtual defect image, a thin edge indicating the position of a generated defect (e.g., a crack) may be indicated. The thin edge may be in an identification color (e.g., red) of the generated defect type (e.g., ‘crack’).

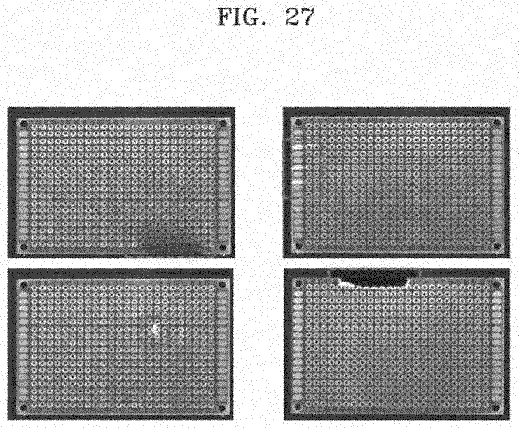

FIG. 27 illustrates examples of virtual defect images generated in the automatic mode. The upper left image may be generated with soot, the upper right image may be generated with a scratch, the lower left image may be generated with a dent, and the lower right image may be generated with a crack.

Referring back to FIG. 26, the user may remove a generated virtual defect (i.e., the virtual defect sketch VDS1) by using, for example, virtual defect edit icons 263. According to a user input, a plurality of virtual defects may be generated in one virtual defect image, and the user may remove only a virtual defect desired to be removed, by using the virtual defect edit icons 263.

In addition, the user may remove one virtual defect image from a plurality of generated virtual defect images displayed in the generated image list area 261.

The processor 12 may store generated (and edited) virtual defect images in a specified path based on receiving a user input with respect to an ‘Export’ button 264.

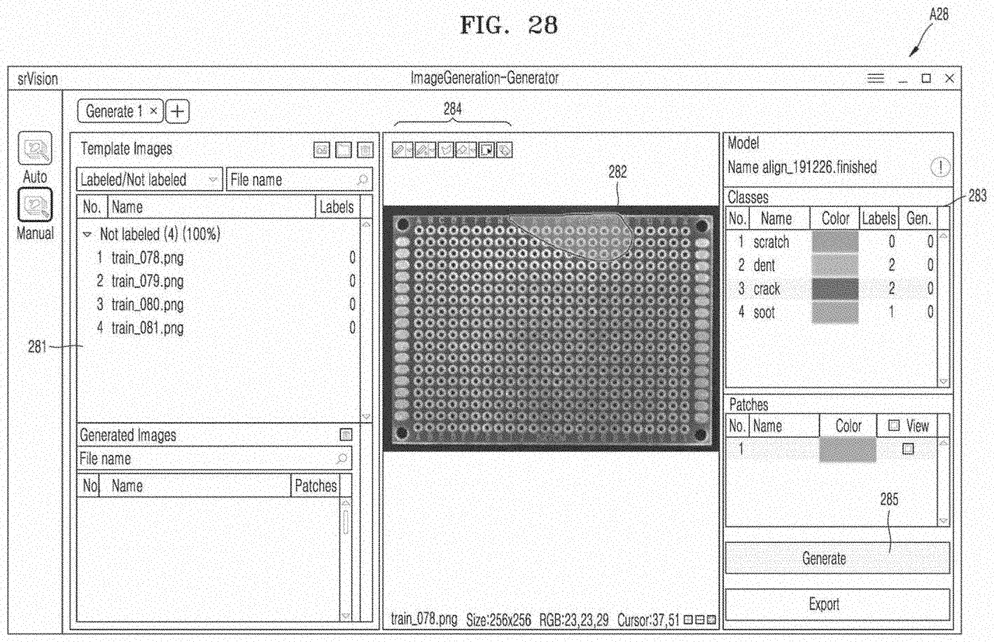

Hereinafter, operation S222 of generating a virtual defect image in the manual mode will be described in detail. FIGS. 28 to 30 illustrate examples of screens for performing manual-mode generation according to an embodiment of the present disclosure.

Referring to FIG. 28, one or more second normal images (i.e., template images) in which defects are to be generated may be loaded through a template image area 281 of a screen A28. In an image area 282, a second normal image selected from among the second normal images listed in the template image area 281 may be displayed.

Meanwhile, the screen A28 may include a defect type area 283 in which defect types stored in relation to a currently loaded model (i.e., a virtual defect image generation model) are displayed.

In the manual mode, the processor 12 may generate a defect of a certain type on the manually marked region by using manually marked region information based on an input made by the user for marking (i.e., sketching) a region in which a defect is to be generated on a second normal image.

For example, the user may select the type of a defect to be generated from among defect types included in the defect type area 283, and sketch the shape of the corresponding defect type on the displayed image (i.e., a second normal image or a template image) by using defect region sketch icons 284. Thereafter, the processor 12 may generate a virtual defect image by inserting a virtual defect corresponding to the shape of the sketch into a template image. This operation is described above with reference to FIG. 4, and may be similar to the labeling operation described above.

Through the manual-mode generation operation, a virtual defect having a sophisticated or complicated shape may be generated.

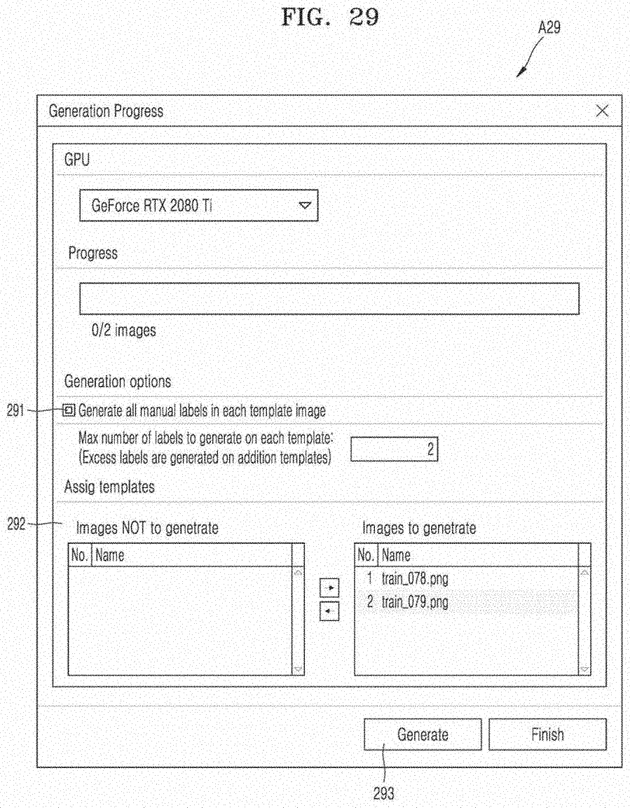

Meanwhile, the processor 12 may display a screen A29 of FIG. 29 based on a user input with respect to a ‘Generate’ button 285. When a checkbox 291 corresponding to “Generate all manual labels in each template image” is checked, defects may be generated according to defect regions for respective defect types marked by the user. When the checkbox 291 is unchecked, the maximum number of defects to be generated per template image may be input. In this case, when eight defects are drawn on one template image and the maximum number of defects is set to 2, the virtual defect image generation model may automatically generate several virtual defect images in each of which one or two defects are generated.

According to an embodiment, through a one area 292 displayed on the screen A29, template images to be generated as virtual defect images may be selected from among template images to which sketches by the user are applied. Thereafter, a virtual defect image may be generated in the manual mode through a user input with respect to a ‘Generate’ button 293.

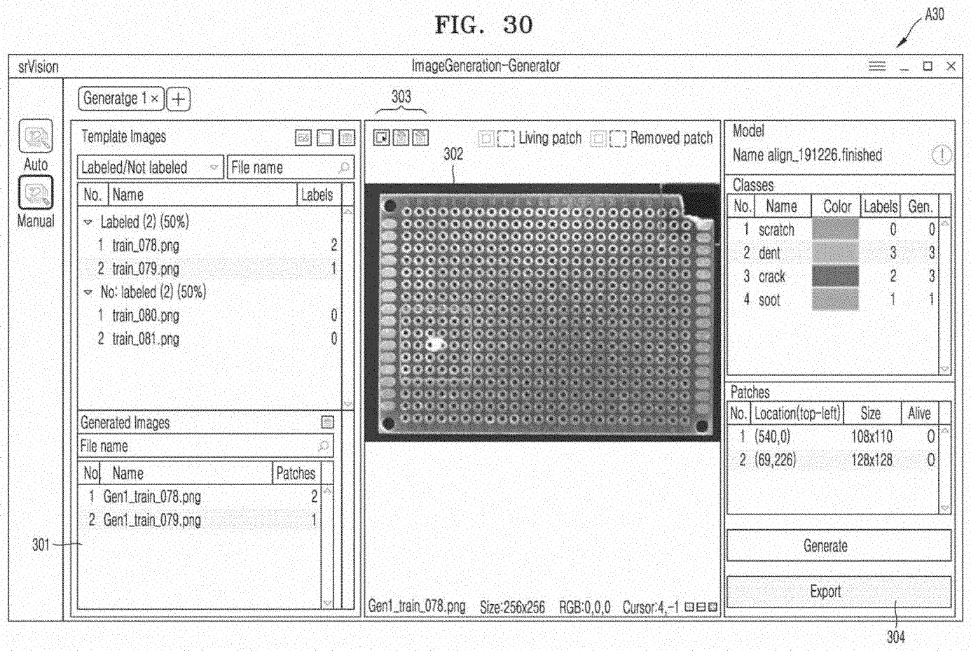

Thereafter, generated virtual defect images may be displayed on a screen A30 of FIG. 30. A list of generated virtual defect images may be displayed in a generated image list area 301 of the screen A30. When one virtual defect image displayed in the generated image list area 301 is clicked, the corresponding virtual defect image may be displayed in an image area 302. On the displayed virtual defect image, a thin edge indicating the position of a generated defect may be indicated. The thin edge may be in, for example, an identification color of the type of the generated defect.

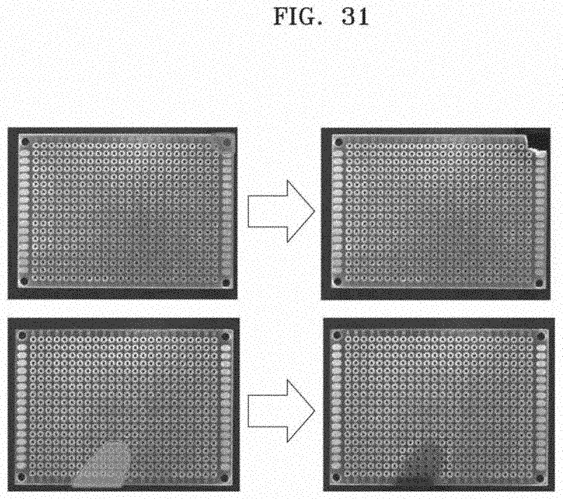

FIG. 31 illustrates examples of virtual defect images generated in the manual mode.

Referring back to FIG. 30, the user may remove a generated virtual defect (i.e., the virtual defect sketch VDS2) by using, for example, virtual defect edit icons 263. A plurality of virtual defects may be generated in one virtual defect image, and the user may remove only a virtual defect desired to be removed, by using the virtual defect edit icons 263.

In addition, the user may remove one virtual defect image from one or more generated virtual defect images displayed in the generated image list area 301.

The processor 12 may store generated (and edited) virtual defect images in a specified path based on receiving a user input with respect to an ‘Export’ button 304.

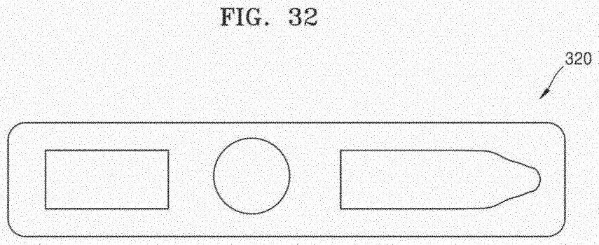

FIGS. 32 to 34 illustrate examples of a case in which automatic-mode generation of a virtual defect image is useful and a case in which the manual-mode generation of a virtual defect image is useful, according to an embodiment of the present disclosure.

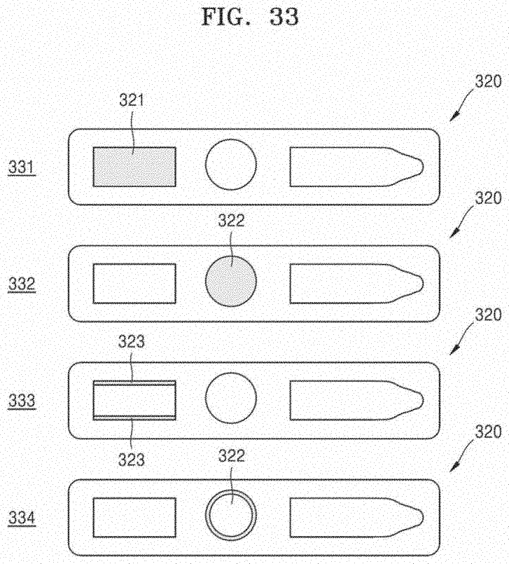

FIG. 32 illustrates a schematic diagram of a certain product 320 (e.g., the upper end of a battery). FIG. 33 illustrates cases in which automatic-mode generation is advantageous or possible for the product 320. A first example 331 shows a case in which a defect region of a quadrangular area may be set on a quadrangular first portion 321 of the product 320. A second example 332 shows a case in which a defect region of a circular area may be set on a circular second portion 322 of the product 320.

For example, within the areas of the first portion 321 and the second portion 322, the defect type ‘scratch’ or ‘foreign substance’ (or ‘colored foreign substance’) may occur. Thus, for example, the user may select (or activate) the defect type ‘scratch’ or ‘foreign substance’, and mark a defect region of a quadrangular area on the first portion 321 and a defect region of a circular area on the second portion 322 by using provided icons.

A third example 333 shows a case in which a defect region of a straight line may be set on third portions 323 of the product 320. The third portions 323 may be, for example, some of edges of the first portion 321. A fourth example 334 shows a case in which a defect region of a circular enclosure may be set on an edge of the circular second portion 322 of the product 320.

For example, in the third portions 323 and the edge of the second portion 322, an outflow of an adhesive or electrolyte, or contamination thereby may occur. Accordingly, for example, the defect type of ‘colored foreign substance’ may occur in the third portions 324 and the edge of the second portion 322. Thus, the user may select (or activate) the defect type ‘colored foreign substance’ (e.g., ‘red foreign substance’, ‘black foreign substance’, ‘blue foreign substance’, etc.), and mark a defect region of a straight line on the third portions 323 and a defect region of a circular enclosure on the edge of the second portion 322 by using the provided icons.

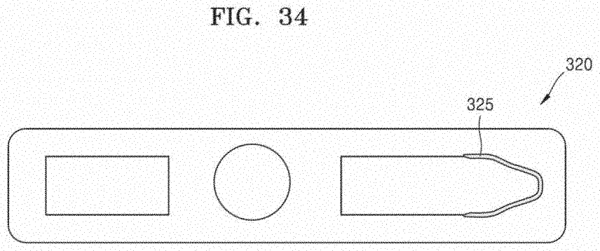

FIG. 34 illustrates cases in which manual-mode generation is advantageous or possible for the product 320. For example, the product 320 may mainly include a complicated shape, such as a fifth portion 325. In this case, in operation S2 of generating a virtual defect image, the manual mode may be selected, then a defect type that may occur in the complicated shape may be selected (or activated), and a defect region that may occur in the complicated shape may be manually marked.

For example, in the fifth portion 325, an outflow of an adhesive or electrolyte, or contamination thereby may occur. Thus, for example, the defect type ‘colored foreign substance’ may occur in the fifth portion 325. Thus, the user may manually set a defect region by selecting (or activating) the defect type ‘colored foreign substance’ (e.g., ‘red foreign substance’, ‘black foreign substance’, ‘blue foreign substance’, etc.) and sketching the shape of a defect desired to be generated along the fifth portion 325 by using provided sketch icons.

In various embodiments of the present disclosure, various types of virtual defect images may be generated as much as desired by performing both operation S221 of generating a virtual defect image in the automatic mode and operation S222 of generating a virtual defect image in the manual mode. Accordingly, the performance of training of a defect detection model (operation S3) may be improved by using variously generated virtual defect images.

The term ‘module’ as used herein may include a unit implemented in hardware, software, or firmware, and may be used interchangeably with, for example, the terms ‘logic’, ‘logic block’, ‘circuitry’, etc. A module may be a single integral component, or a minimum unit or part thereof, adapted to perform one or more functions. For example, a module may be implemented as an application-specific integrated circuit (ASIC).

Various embodiments of the present disclosure may be embodied as software (e.g., the program 16) including instructions stored in a storage medium (e.g., the memory 15, an internal or external memory) readable by a machine (e.g., a computer). The machine is a device capable of invoking stored instructions from the storage medium and operating based on the invoked instructions, and may include an electronic device (e.g., the electronic device 10) according to the embodiments of the present disclosure. When the instructions are executed by a processor (e.g., the processor 12), the processor may perform the function corresponding to the instructions, either directly, or by using other components under the control by the processor. The instructions may include code generated or executed by a compiler or an interpreter. The machine-readable storage medium may be provided in the form of a non-transitory storage medium. Here, the term ‘non-transitory’ simply means that the storage medium is a tangible device, and does not include a signal, but this term does not differentiate between where data is semi-permanently stored in the storage medium and where the data is temporarily stored in the storage medium.

According to an embodiment, the method according to various embodiments disclosed herein may be included in a computer program product and provided. The computer program product may be traded between a seller and a purchaser as a commodity. The computer program product may be distributed in the form of a machine-readable storage medium, or may be distributed online through an application store (e.g., Play Store™). When distributed online, at least a portion of the computer program product may be temporarily stored in a storage medium such as a manufacturer's server, an application store's server, or a memory of a relay server.

Although the present disclosure has been described with reference to the embodiments illustrated in the drawings, they are merely exemplary, and it will be understood by one of skill in the art that various modifications and equivalent embodiments may be made therefrom. Therefore, the true technical protection scope of the present disclosure should be determined by the appended claims.

1. A method, performed by an electronic device, of generating a virtual defect image, the method comprising:
training a virtual defect image generation model based at least on a first normal image and a defect image of a first product, and a user input; and
generating a virtual defect image from a second normal image of a second product by using the trained virtual defect image generation model,
wherein the generating of the virtual defect image includes
generating the virtual defect image through the virtual defect image generation model by using information about a defect region of a preset shape, and
generating the virtual defect image through the virtual defect image generation model by using manually marked region information based on an input made by a user for marking a region in which a defect is to be generated.

2. The method of claim 1, wherein
the first product and the second product are of a completely same type or are of a same type but have different standards or versions, and
the first normal image and the second normal image are identical to or different from each other.

3. The method of claim 1, wherein
the training of the virtual defect image generation model includes setting defect types, which are occurrable in the first product, and
the generating of the virtual defect image includes
receiving, based on a user input, information about a defect region in which each of at least some of the set defect types is occurrable.

4. The method of claim 1, wherein
the training of the virtual defect image generation model includes:
collecting data for a database based on first normal images and defect images of products of a plurality of different versions including the first product and performing preprocessing on the database; and
training the virtual defect image generation model by selecting only some of the products of the plurality of different versions.

5. A computer program stored in a computer-readable storage medium for executing the method of claim 1 by using a computer.
